(19) United States
(12) Patent Application Publication
(10) Pub. No.: US 2017/0120123 A1
(43) Pub. Date: May 4, 2017

(54) ELECTRONIC APPARATUS, SYSTEM, METHOD, PROGRAM, AND RECORDING MEDIUM

(71) Applicant: SEIKO EPSON CORPORATION, Tokyo (JP)

(72) Inventor: Norihisa HAGIWARA, Hachioji-shi (JP)

(73) Assignee: SEIKO EPSON CORPORATION, Tokyo (JP)

(21) Appl. No.: 15/292,943

(22) Filed: Oct. 13, 2016

(30) Foreign Application Priority Data
Nov. 4, 2015 (JP) 2015-216748
Feb. 22, 2016 (JP) 2016-031282

(51) Int. Cl. A63B 60/46; G09B 19/00; A63B 24/00

(52) U.S. Cl. CPC A63B 60/46; A63B 24/0003; G09B 19/0038; A63B 2220/803; A63B 2102/32

(57) ABSTRACT

An electronic apparatus includes a presentation portion that presents a ratio between a length of a trajectory of a predetermined portion of an exercise equipment and a length of a portion of the trajectory included in a predetermined region in a predetermined period of a swing, or presents a ratio between the predetermined period of the swing and time for which the predetermined portion of the exercise equipment is included in the predetermined region in the predetermined period.

### BACKGROUND

1. Technical Field

The present invention relates to an electronic apparatus, a system, a method, a program, and a recording medium.

2. Related Art

In the related art, a golf support apparatus which captures an image of a golf swing with a camera, and displays a line segment serving as a reference of a person on the captured image, has been proposed (refer to JP-A-2015-33476). For example, FIG. 15 of JP-A-2015-33476 illustrates an example in which a line segment connecting the waist of a player to a ball, and a line segment connecting the head of the player to the ball are displayed. The player can recognize a swing attitude of the player on the basis of a form drawn with the two line segments.

However, these line segments cannot quantitatively indicate a feature of the swing. Apparatuses displaying a user's swing trajectory also have been proposed, but the user may not sufficiently understand features of the user's swing on the basis of only the swing trajectory.

### SUMMARY

An advantage of some aspects of the invention is to provide an electronic apparatus, a system, a method, a program, and a recording medium, capable of presenting or calculating an index indicating a feature of a swing trajectory in a quantitative manner.

The invention can be implemented as the following forms or application examples.

### APPLICATION EXAMPLE 1

An electronic apparatus according to this application example includes a presentation portion that presents a ratio in which a predetermined portion of an exercise equipment is included in a predetermined region in a predetermined period of a swing.

Therefore, the electronic apparatus can quantitatively present, as a ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 2

A method according to this application example includes a procedure of presenting a ratio in which a predetermined portion of an exercise equipment is included in a predetermined region within a predetermined period of a swing.

Therefore, according to the method of the application example, it is possible to quantitatively present, as a ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 3

A method according to this application example includes a procedure of calculating a ratio in which a predetermined portion of an exercise equipment is included in a predetermined region within a predetermined period of a swing.

Therefore, according to the method of the application example, it is possible to quantitatively calculate, as a ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 4

A program according to this application example causes a computer to execute a procedure of presenting a ratio in which a predetermined portion of an exercise equipment is included in a predetermined region in a predetermined period of a swing.

Therefore, according to the program of the application example, the computer can quantitatively present, as a ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 5

A program according to this application example causes a computer to execute a procedure of calculating a ratio in which a predetermined portion of an exercise equipment is included in a predetermined region within a predetermined period of a swing.

Therefore, according to the program of the application example, the computer can quantitatively calculate, as a ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 6

A recording medium according to this application example records a program causing a computer to execute a procedure of presenting a ratio in which a predetermined portion of an exercise equipment is included in a predetermined region within a predetermined period of a swing.

Therefore, according to the recording medium of the application example, the computer can quantitatively present, as a ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 7

A recording medium according to this application example records a program causing a computer to execute a procedure of calculating a ratio in which a predetermined portion of an exercise equipment is included in a predetermined region in a predetermined period of a swing.

Therefore, according to the recording medium of the application example, the computer can quantitatively calculate, as a ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 8

An electronic apparatus according to this application example includes a presentation portion that presents a ratio between a length of a trajectory of a predetermined portion of an exercise equipment and a length of a portion of the trajectory included in a predetermined region in a predetermined period of a swing, or presents a ratio between the predetermined period of the swing and time for which the predetermined portion of the exercise equipment is included in the predetermined region in the predetermined period.

Therefore, the electronic apparatus can quantitatively present, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 9

In the electronic apparatus according to the application example, the predetermined region may be a region interposed between a first plane and a second plane, the first plane being specified by a first axis along a target hit ball direction and a second axis along the longitudinal direction of the exercise equipment before starting the swing, and the second plane being a plane which includes the first axis and forms a predetermined angle with the first plane, or a plane which is parallel to the first plane.

### APPLICATION EXAMPLE 10

An electronic apparatus according to this application example includes a calculation portion that calculates a ratio between a length of a trajectory of a predetermined portion of an exercise equipment and a length of a portion of the trajectory included in a predetermined region in a predetermined period of a swing, or calculates a ratio between the predetermined period of the swing and time for which the predetermined portion of the exercise equipment is included in the predetermined region in the predetermined period.

Therefore, the electronic apparatus can quantitatively calculate, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 11

In the electronic apparatus according to the application example, the predetermined region may be a region interposed between a first plane and a second plane, the first plane being specified by a first axis along a target hit ball direction and a second axis along the longitudinal direction of the exercise equipment before starting the swing, and the second plane being a plane which includes the first axis and forms a predetermined angle with the first plane, or a plane which is parallel to the first plane.

Therefore, if this ratio is used as at least one of indexes, for example, it is possible to objectively diagnose the quality of a user's swing.

### APPLICATION EXAMPLE 12

In the electronic apparatus according to the application example, the calculation portion may divide time-series data regarding positions of the predetermined portion in the predetermined period into a plurality of sections, calculate a position of the predetermined portion in each section on the basis of time-series data for each section, count the number of positions included in the predetermined region among the positions in the respective sections, and set a value obtained by dividing the counted number by the number of sections as the ratio.

The calculation portion uses time-series data of positions as data of positions in respective sections when counting the number of positions included in the predetermined region. In this case, the number of position data items is reduced, and thus this is efficient since the number of times of determining whether or not each position is included in the predetermined region can be reduced.

### APPLICATION EXAMPLE 13

In the electronic apparatus according to the application example, the calculation portion may determine whether or not a position of the predetermined portion is included in the predetermined region on the basis of an inclination of the first plane in a predetermined plane intersecting the first plane and the second plane, an inclination of the second plane in the predetermined plane, and coordinates of a position of the predetermined portion in the predetermined plane.

In this case, the calculation portion can perform determination through only multiplication and magnitude comparison, and thus a trigonometric function (a tan function or the like) is not required to be used. Therefore, the electronic apparatus can reduce a calculation amount required in determination.

### APPLICATION EXAMPLE 14

In the electronic apparatus according to the application example, the calculation portion may calculate the ratio on the basis of output from an inertial sensor.

The inertial sensor can accurately measure a position of a predetermined portion of the exercise equipment. Therefore, the calculation portion can accurately calculate a ratio compared with a case of calculating a ratio on the basis of a swing image or the like.

### APPLICATION EXAMPLE 15

In the electronic apparatus according to the application example, the predetermined period may be at least one of a first period from starting of the swing to impact, a second period from starting of the swing to a top, a third period from the top to the impact, a fourth period from starting of the swing to halfway back, and a fifth period from halfway down to the impact.

Therefore, the electronic apparatus can set a ratio presentation target or calculation target to a period from a predetermined timing of the swing to another predetermined timing.

### APPLICATION EXAMPLE 16

In the electronic apparatus according to the application example, the predetermined period may be a period including the second period and the third period.

Therefore, the electronic apparatus can set a ratio presentation target or calculation target to a period including a backswing period and a downswing period.

### APPLICATION EXAMPLE 17

In the electronic apparatus according to the application example, the predetermined period is a period including the fourth period and the fifth period.

Therefore, the electronic apparatus can set a ratio presentation target or calculation target to a period including a first half backswing period and a second half downswing period.

### APPLICATION EXAMPLE 18

A system according to this application example includes the electronic apparatus according to the application example, and the inertial sensor.

Therefore, for example, if the inertial sensor is mounted on, for example, an exercise equipment or a user's body, the electronic apparatus can quantitatively calculate, as a distance or temporal ratio, a relationship between a case where the predetermined portion is not included in the predetermined region in the predetermined period and a case where the predetermined portion is included in the predetermined region in the predetermined period, on the basis of output from the inertial sensor. This ratio can accurately indicate a feature of a swing trajectory in the predetermined period.

### APPLICATION EXAMPLE 19

A method according to this application example includes presenting a ratio between a length of a trajectory of a predetermined portion of an exercise equipment and a length of a portion of the trajectory included in a predetermined region in a predetermined period of a swing, or presenting a ratio between the predetermined period of the swing and time for which the predetermined portion of the exercise equipment is included in the predetermined region in the predetermined period.

Therefore, according to the method of the application example, it is possible to quantitatively present, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 20

A method according to this application example includes calculating a ratio between a length of a trajectory of a predetermined portion of an exercise equipment and a length of a portion of the trajectory included in a predetermined region in a predetermined period of a swing, or calculating a ratio between the predetermined period of the swing and time for which the predetermined portion of the exercise equipment is included in the predetermined region in the predetermined period.

Therefore, according to the method of the application example, it is possible to quantitatively calculate, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 21

A program according to this application example causes a computer to execute a procedure of presenting a ratio between a length of a trajectory of a predetermined portion of an exercise equipment and a length of a portion of the trajectory included in a predetermined region in a predetermined period of a swing, or presenting a ratio between the predetermined period of the swing and time for which the predetermined portion of the exercise equipment is included in the predetermined region in the predetermined period.

Therefore, according to the program of the application example, the computer can quantitatively present, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 22

A program according to this application example causes a computer to execute a procedure of calculating a ratio between a length of a trajectory of a predetermined portion of an exercise equipment and a length of a portion of the trajectory included in a predetermined region in a predetermined period of a swing, or calculating a ratio between the predetermined period of the swing and time for which the predetermined portion of the exercise equipment is included in the predetermined region in the predetermined period.

Therefore, according to the program of the application example, the computer can quantitatively calculate, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 23

A recording medium according to this application example records a program causing a computer to execute a procedure of presenting a ratio between a length of a trajectory of a predetermined portion of an exercise equipment and a length of a portion of the trajectory included in a predetermined region in a predetermined period of a swing, or presenting a ratio between the predetermined period of the swing and time for which the predetermined portion of the exercise equipment is included in the predetermined region in the predetermined period.

Therefore, according to the recording medium of the application example, the computer can quantitatively present, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### APPLICATION EXAMPLE 24

A recording medium according to this application example records a program causing a computer to execute a procedure of calculating a ratio between a length of a trajectory of a predetermined portion of an exercise equipment and a length of a portion of the trajectory included in a predetermined region in a predetermined period of a swing, or calculating a ratio between the predetermined period of the swing and time for which the predetermined portion of the exercise equipment is included in the predetermined region in the predetermined period.

Therefore, according to the recording medium of the application example, the computer can quantitatively calculate, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### BRIEF DESCRIPTION OF THE DRAWINGS

The invention will be described with reference to the accompanying drawings, wherein like numbers reference like elements.

FIG. 1 is a diagram illustrating an outline of a swing analysis system of the present embodiment.

FIG. 2 is a diagram illustrating examples of a position at which and a direction in which a sensor unit is attached.

FIG. 3 is a diagram illustrating procedures of actions performed by a user until the user hits a ball.

FIG. 4 is a diagram illustrating an example of an input screen of physical information and golf club information.

FIG. 5 is a diagram illustrating a swing action.

FIG. 6 is a diagram illustrating a configuration example of the swing analysis system.

FIG. 7 is a plan view in which a golf club and the sensor unit are viewed from a negative side of an X axis during standing still of the user.

FIG. 8 is a diagram illustrating a shaft plane and a Hogan plane.

FIG. 9 is a view in which a sectional view of the shaft plane which is cut in a YZ plane is viewed from the negative side of the X axis.

FIG. 10 is a view in which a sectional view of the Hogan plane which is cut in the YZ plane is viewed from the negative side of the X axis.

FIG. 11 is a diagram illustrating an example of a relationship between keeping determination references (a first threshold value θₛ and a second threshold value θₕ) and position coordinates (Yₙ, Zₙ) of a predetermined portion of a golf club in a first embodiment.

FIG. 12 is a diagram illustrating an example of a relationship between keeping determination references (a first threshold value LYₙ and a second threshold value UYₙ) and position coordinates (Yₙ, Zₙ) of a predetermined portion of a golf club in a third embodiment.

FIG. 13 illustrates an example of a display screen of swing analysis data including a V zone keeping ratio R.

FIG. 14 is a flowchart illustrating examples of procedures of a swing analysis process in the first embodiment.

FIG. 15 is a flowchart illustrating examples of procedures of a V zone keeping ratio calculation process in the first embodiment.

FIG. 16 is a flowchart illustrating examples of procedures of a swing analysis process in a second embodiment.

FIG. 17 is a flowchart illustrating examples of procedures of a V zone keeping ratio calculation process in the second embodiment.

FIG. 18 is a flowchart illustrating examples of procedures of a V zone keeping ratio calculation process in the third embodiment.

FIG. 19 is a diagram illustrating a modification example of a predetermined region.

FIG. 20 is a diagram illustrating a modification example in which a plurality of predetermined regions are provided.

FIG. 21 is a diagram illustrating a modification example of displaying a swing plane.

FIG. 22 is a diagram illustrating a modification example of displaying images of a shaft at respective time points.

FIG. 23 is a diagram illustrating a modification example of a first plane and a second plane.

### DESCRIPTION OF EXEMPLARY EMBODIMENTS

Hereinafter, preferred embodiments of the invention will be described with reference to the drawings. The embodiments described below are not intended to improperly limit the content of the invention disclosed in the appended claims. In addition, all constituent elements described below are not essential constituent elements of the invention.

Hereinafter, a swing analysis system performing analysis of a golf swing will be described as an example.

### 1. First Embodiment

### 1-1. Outline of Swing Analysis System

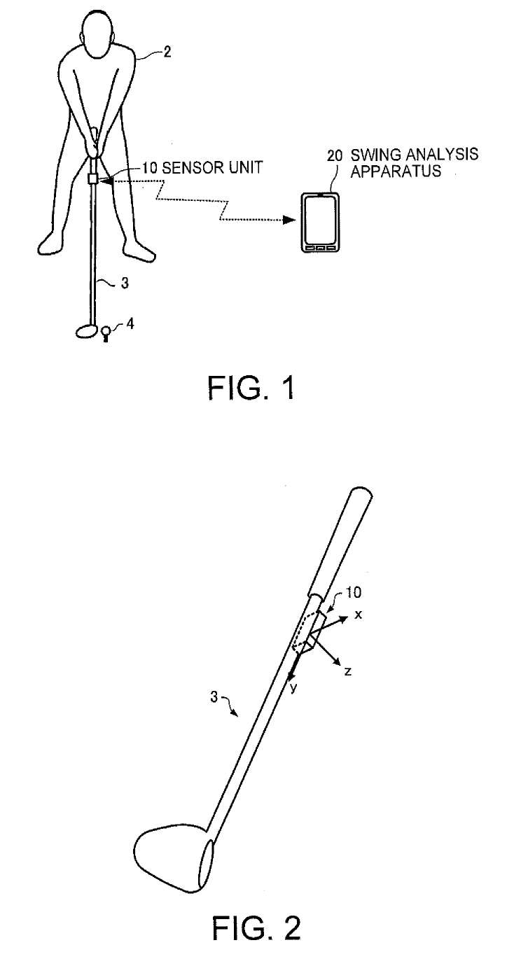

FIG. 1 is a diagram illustrating an outline of a swing analysis system of the present embodiment.

As illustrated in FIG. 1, a swing analysis system (an example of a system) of the present embodiment is configured to include a sensor unit 10 (an example of an inertial sensor), and a swing analysis apparatus 20 (an example of an electronic apparatus).

The sensor unit 10 (an example of an inertial sensor) can measure acceleration generated in each axial direction of three axes and angular velocity generated about each of the three axes, and is attached to a golf club 3 (an example of an exercise equipment).

### 1-2. Attachment Examples of Sensor Unit

FIG. 2 is a diagram illustrating examples of a position at which and a direction in which the sensor unit 10 is attached to the golf club 3.

As illustrated in FIG. 2, an attitude of the sensor unit 10 attached to the golf club 3 is set so that one axis (here, a y axis) of three detection axes (an x axis, the y axis, and a z axis) of the sensor unit 10 matches an axis in a longitudinal direction of the shaft of the golf club 3 (in other words, a long axis direction of the shaft).

An attitude of another axis (here, the x axis) of the sensor unit 10 with respect to the golf club 3 is an attitude in which the x axis is along a target line (target hit ball direction).

Preferably, the sensor unit 10 is attached to the golf club 3 at a position close to a grip to which impact at ball hitting is hardly forwarded and at which acceleration measured during a swing is small. The “shaft” mentioned here is a shaft portion other than a head of the golf club 3 and also includes the grip. A “face surface” indicates a ball hitting surface of the head of the golf club 3.

### 1-3. User's Actions

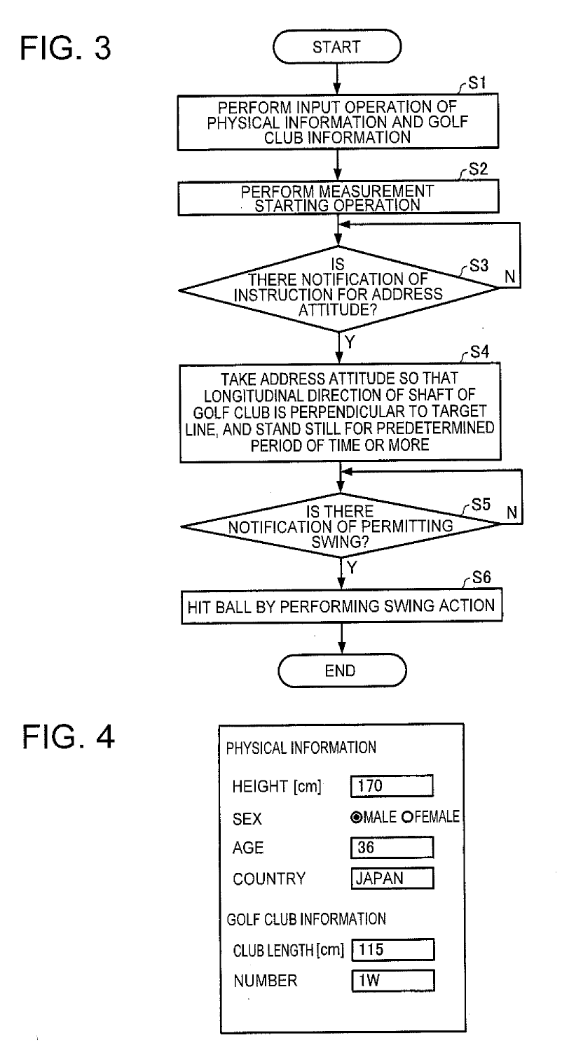

FIG. 3 is a diagram illustrating procedures of actions performed by a user 2 until the user hits the ball. Hereinafter, respective steps in FIG. 3 will be described in order.

Step S1: The user 2 performs an input operation of physical information of the user 2, information (golf club information) regarding the golf club 3 used by the user 2, and the like as necessary via the swing analysis apparatus 20. The physical information includes at least one of information regarding a height, a length of the arm, and a length of the leg of the user 2, and may further include information regarding a sex or other information. The golf club information includes at least one of information regarding a length (club length) of the golf club 3 and the type (number) of golf club 3.

Step S2: The user 2 performs a measurement starting operation (an operation for starting measurement in the sensor unit 10) via the swing analysis apparatus 20. The swing analysis apparatus 20 transmits a measurement starting command to the sensor unit 10, and the sensor unit 10 receives the measurement starting command and starts measurement of three-axis accelerations and three-axis angular velocities. The sensor unit 10 measures three-axis accelerations and three-axis angular velocities in a predetermined sampling cycle (for example, Δt=1 ms), and sequentially transmits the measured data to the swing analysis apparatus 20. Communication between the sensor unit 10 and the swing analysis apparatus 20 is wireless communication or wired communication.

Step S3: The user 2 determines whether or not a notification (for example, a notification using a voice) of giving an instruction for taking an address attitude has been received from the swing analysis apparatus 20, transitions to step S4 if the notification has been received (Y in S3), and waits if the notification has not been received (N in S3).

Step S4: The user 2 takes an address attitude so that the longitudinal direction of the shaft of the golf club 3 is perpendicular to a target line (target hit ball direction), and stands still for a predetermined period of time or more.

Step S5: The user 2 determines whether or not a notification (for example, a notification using a voice) of permitting a swing has been received from the swing analysis apparatus 20, transitions to step S6 if the notification has been received (Y in S5), and keeps standing still if the notification has not been received (N in S5).

Step S6: The user 2 performs a swing action from the address attitude so as to hit a golf ball 4. Thereafter, the swing analysis apparatus 20 analyzes the swing action in which the user 2 has hit the ball by using the golf club 3 on the basis of measured data from the sensor unit 10.

### 1-4. Input Screen

FIG. 4 is a diagram illustrating an example of an input screen of physical information and golf club information, displayed on the swing analysis apparatus 20.

The user 2 inputs physical information such as a height, a sex, an age, and a country, and inputs golf club information such as a club length (a length of the shaft), and a number on the input screen illustrated in FIG. 4. Information included in the physical information is not limited thereto, and, the physical information may include, for example, at least one of information regarding a length of the arm and a length of the leg instead of or along with the height. Similarly, information included in the golf club information is not limited thereto, and, for example, the golf club information may not include at least one of information regarding the club length and the number, and may include other information.

### 1-5. Swing Action

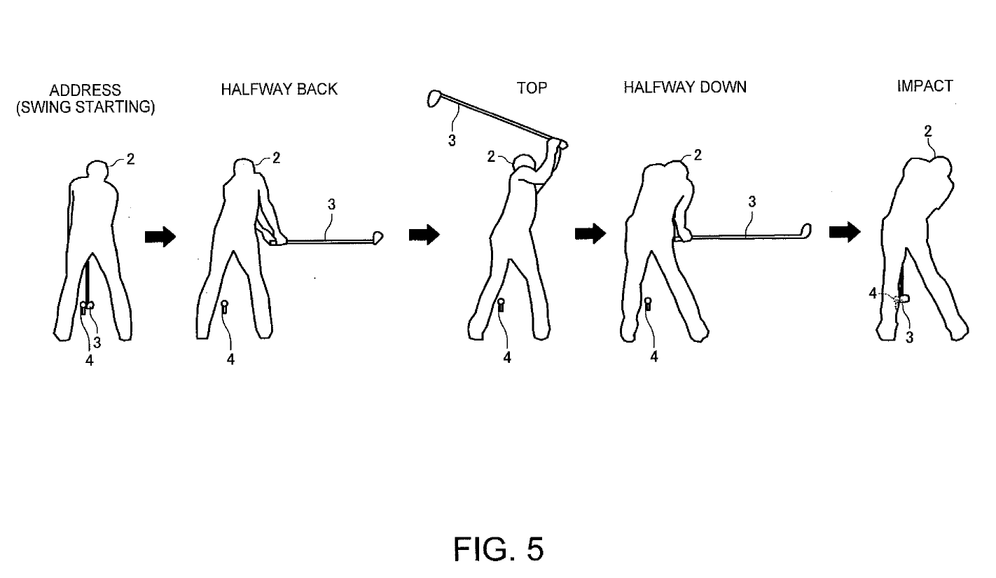

FIG. 5 is a diagram for explaining a swing action.

As illustrated in FIG. 5, the swing action performed by the user 2 includes an action reaching impact (ball hitting) at which the golf ball 4 is hit through respective states of halfway back at which the shaft of the golf club 3 becomes horizontal during a backswing after starting a swing (backswing), a top at which the swing changes from the backswing to a downswing, and halfway down at which the shaft of the golf club 3 becomes horizontal during the downswing.

### 1-6. Configuration of Swing Analysis System

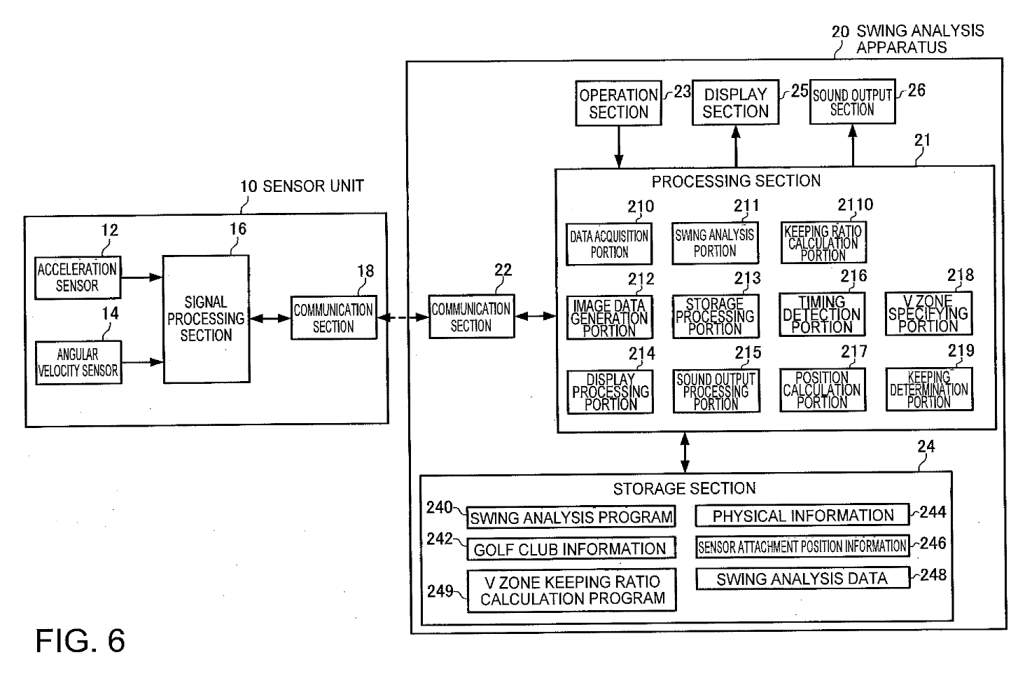

FIG. 6 is a diagram illustrating a configuration example of the swing analysis system.

As illustrated in FIG. 6, in the present embodiment, the sensor unit 10 is configured to include an acceleration sensor 12, an angular velocity sensor 14, a signal processing section 16, and a communication section 18. However, the sensor unit 10 may have a configuration in which some of the constituent elements are deleted or changed as appropriate, or may have a configuration in which other constituent elements are added thereto.

The acceleration sensor 12 measures respective accelerations in three axial directions which intersect (ideally, orthogonal to) each other, and outputs digital signals (acceleration data) corresponding to magnitudes and directions of the measured three-axis accelerations.

The angular velocity sensor 14 measures respective angular velocities in three axial directions which intersect (ideally, orthogonal to) each other, and outputs digital signals (angular velocity data) corresponding to magnitudes and directions of the measured three-axis angular velocities.

The signal processing section 16 receives the acceleration data and the angular velocity data from the acceleration sensor 12 and the angular velocity sensor 14, respectively, stores the data in a storage portion (not illustrated), adds time information to the stored measured data (acceleration data and angular velocity data) so as to generate packet data conforming to a communication format, and outputs the packet data to the communication section 18.

Ideally, the acceleration sensor 12 and the angular velocity sensor 14 are provided in the sensor unit 10 so that the three axes thereof match three axes (an x axis, a y axis, and a z axis) of an orthogonal coordinate system (sensor coordinate system) defined for the sensor unit 10, but, actually, errors occur in installation angles. Therefore, the signal processing section 16 preferably performs a process of converting the acceleration data and the angular velocity data into data in the xyz coordinate system by using a correction parameter which is calculated in advance according to the installation angle errors.

The signal processing section 16 may perform a process of correcting the temperatures of the acceleration sensor 12 and the angular velocity sensor 14. The acceleration sensor 12 and the angular velocity sensor 14 may have a temperature correction function.

The acceleration sensor 12 and the angular velocity sensor 14 may output analog signals, and, in this case, the signal processing section 16 may A/D convert an output signal from the acceleration sensor 12 and an output signal from the angular velocity sensor 14 so as to generate measured data (acceleration data and angular velocity data), and may generate communication packet data by using the data.

The communication section 18 performs a process of transmitting packet data received from the signal processing section 16 to the swing analysis apparatus 20, or a process of receiving various control commands such as a measurement starting command from the swing analysis apparatus 20 and sending the control command to the signal processing section 16. The signal processing section 16 performs various processes corresponding to control commands.

As illustrated in FIG. 6, the swing analysis apparatus 20 is configured to include a processing section 21 (an example of a computer), a communication section 22, an operation section 23, a storage section 24, a display section 25 (an example of a presentation portion), and a sound output section 26 (an example of a presentation portion). However, the swing analysis apparatus 20 may have a configuration in which some of the constituent elements are deleted or changed as appropriate, or may have a configuration in which other constituent elements are added thereto.

The communication section 22 performs a process of receiving packet data transmitted from the sensor unit 10 and sending the packet data to the processing section 21, or a process of transmitting a control command from the processing section 21 to the sensor unit 10.

The operation section 23 performs a process of acquiring operation data from the user 2 and sending the operation data to the processing section 21. The operation section 23 may be, for example, a touch panel type display, a button, a key, or a microphone.

The storage section 24 is constituted of, for example, various IC memories such as a read only memory (ROM), a flash ROM, and a random access memory (RAM), or a recording medium such as a hard disk or a memory card. The storage section 24 stores a program for the processing section 21 performing various calculation processes or a control process, or various programs or data for realizing application functions.

In the present embodiment, the storage section 24 stores a swing analysis program 240 which is read by the processing section 21 and executes a swing analysis process (an example of a method), and a V zone keeping ratio calculation program 249 which is read by the processing section 21 and executes a V zone keeping ratio calculation process (an example of a method). The swing analysis program 240 and the V zone keeping ratio calculation program 249 may be stored in a nonvolatile recording medium (computer readable recording medium) in advance, and may be received from a server (not illustrated) by the processing section 21 via a network so as to be stored in the storage section 24.

In the present embodiment, the storage section 24 stores golf club information 242, physical information 244, sensor attachment position information 246, and swing analysis data 248. For example, the user 2 may operate the operation section 23 so as to input specification information regarding the golf club 3 to be used (for example, at least some information such as information regarding a length of the shaft, a position of the centroid thereof, a lie angle, a face angle, a loft angle, and the like) from an input screen, and the input specification information may be used as the golf club information 242. Alternatively, in step S1, the user 2 may input type numbers of the golf club 3 (alternatively, selects a type number from a type number list) and specification information of an input type number among specification information for each type number stored in the storage section 24 in advance may be used as the golf club information 242.

For example, the user 2 may input physical information by operating the operation section 23 from an input screen, and the input physical information may be used as the physical information 244. For example, in step S1, the user 2 may input a distance between an attachment position of the sensor unit 10 and a grip end of the golf club 3 by operating the operation section 23, and the input distance information may be used as the sensor attachment position information 246. Alternatively, the sensor unit 10 may be attached at a defined predetermined position (for example, a distance of 20 cm from the grip end), and thus information regarding the predetermined position may be stored as the sensor attachment position information 246 in advance.

The swing analysis data 248 is data including information regarding a swing analysis process result (index) in the processing section 21 (swing analysis portion 211) along with a time point (date and time) at which a swing was performed, identification information or a sex of the user 2, and the type of golf club 3.

The storage section 24 is used as a work area of the processing section 21, and temporarily stores data which is input from the operation section 23, results of calculation executed by the processing section 21 according to various programs, and the like. The storage section 24 may store data which is required to be preserved for a long period of time among data items generated through processing in the processing section 21.

The display section 25 displays a processing result in the processing section 21 as text, a graph, a table, animation, and other images. The display section 25 may be, for example, a CRT, an LCD, a touch panel type display, and a head mounted display (HMD). A single touch panel type display may realize functions of the operation section 23 and the display section 25.

The sound output section 26 outputs a processing result in the processing section 21 as a sound such as a voice or a buzzer sound. The sound output section 26 may be, for example, a speaker or a buzzer.

The processing section 21 performs a process of transmitting a control command to the sensor unit 10 via the communication section 22, or various computation processes on data which is received from the sensor unit 10 via the communication section 22, according to various programs. The processing section 21 performs other various control processes.

Particularly, in the present embodiment, by executing the swing analysis program 240 (an example of a program), the processing section 21 functions as a swing analysis portion 211, and performs a swing analysis process (an example of a method). By executing the V zone keeping ratio calculation program 249 (an example of a program), the processing section 21 functions as a keeping ratio calculation portion 2110 (an example of a calculation portion), and performs a V zone keeping ratio calculation process (an example of a method). The processing section 21 appropriately functions as a data acquisition portion 210, an image data generation portion 212, a storage processing portion 213, a display processing portion 214, and a sound output processing portion 215, a timing detection portion 216, a position calculation portion 217, a V zone specifying portion 218 (an example of a first specifying portion, and an example of a second specifying portion), and a keeping determination portion 219 (an example of a calculation portion).

The data acquisition portion 210 performs a process of receiving packet data which is received from the sensor unit 10 by the communication section 22, acquiring time information and measured data in the sensor unit 10 from the received packet data, and sending the time information and the measured data to the storage processing portion 213.

The storage processing portion 213 performs read/write processes of various programs or various data for the storage section 24. The storage processing portion 213 performs not only the process of storing the time information and the measured data received from the data acquisition portion 210 in the storage section 24 in correlation with each other, but also a process of storing various pieces of information calculated by the swing analysis portion 211, the swing analysis data 248, or the like in the storage section 24.

The swing analysis portion 211 performs a process of analyzing a swing action of the user 2 by using the measured data (the measured data stored in the storage section 24) output from the sensor unit 10, the data from the operation section 23, or the like, so as to generate the swing analysis data 248 including a time point (date and time) at which the swing was performed, identification information or a sex of the user 2, the type of golf club 3, and information regarding a swing action analysis result (at least some swing analysis data), and preserve the swing analysis data in the storage section 24 or display the swing analysis data on the display section 25.

The swing analysis portion 211 causes the keeping ratio calculation portion 2110 to calculate a V zone keeping ratio in a predetermined period of a swing as at least some indexes included in the swing analysis data. Here, the predetermined period in which a V zone keeping ratio is calculated is at least one of, for example:

(1) a period from swing starting to impact (an example of a first period)

(2) a period from swing starting to a top (backswing) (an example of a second period)

(3) a period from a top to impact (downswing) (an example of a third period)

(4) a period from swing starting to a halfway back (an example of a fourth period)

(5) a period from a halfway down to impact (an example of a fifth period)

Hereinafter, it is assumed that the swing analysis portion 211 of the present embodiment causes the keeping ratio calculation portion 2110 to calculate a V zone keeping ratio for each of the period (2) of a backswing and the period (3) of a downswing.

The image data generation portion 212 performs a process of generating image data corresponding to an image displayed on the display section 25. For example, the image data generation portion 212 generates image data on the basis of various pieces of information received by the data acquisition portion 210.

The display processing portion 214 performs a process of displaying various images (including text, symbols, and the like in addition to an image corresponding to the image data generated by the image data generation portion 212) on the display section 25. For example, the display processing portion 214 displays various screens on the display section 25 on the basis of the image data generated by the image data generation portion 212. For example, the image data generation portion 212 may display an image, text, or the like for notifying the user 2 on the display section 25. For example, the display processing portion 214 may display text information such as text or symbols indicating an analysis result (at least some swing analysis data) in the swing analysis portion 211 on the display section 25 automatically or in response to an input operation performed by the user 2 after a swing action of the user 2 is completed. Alternatively, a display section may be provided in the sensor unit 10, and the display processing portion 214 may transmit image data to the sensor unit 10 via the communication section 22, and various images, text, or the like may be displayed on the display section of the sensor unit 10.

The sound output processing portion 215 performs a process of outputting various sounds (including voices, buzzer sounds, and the like) from the sound output section 26. For example, the sound output processing portion 215 may output a sound for notifying the user 2 from the sound output section 26. For example, the sound output processing portion 215 may output a sound or a voice indicating an analysis result (at least some swing analysis data) in the swing analysis portion 211 from the sound output section 26 automatically or in response to an input operation performed by the user 2 after a swing action of the user 2 is completed. Alternatively, a sound output section may be provided in the sensor unit 10, and the sound output processing portion 215 may transmit various items of sound data or voice data to the sensor unit 10 via the communication section 22, and may output various sounds or voices from the sound output section of the sensor unit 10.

A vibration mechanism may be provided in the swing analysis apparatus 20 or the sensor unit 10, and various pieces of information may be converted into pieces of vibration information by the vibration mechanism so as to be presented to the user 2.

The timing detection portion 216 detects a timing of each of swing starting, a top, and impact, on the basis of measured data output from the sensor unit 10. A method of detecting such a timing will be described later.

The position calculation portion 217 sets a global coordinate system on the basis of the measured data output from the sensor unit 10, and represents a position and an attitude of the sensor unit 10 at each time point t in the global coordinate system. Each time point t is time points t=0, t=Δt, t=2Δt, t=3Δt, . . . which are deviated by the sampling cycle Δt. A method of setting the global coordinate system, and a method of calculating a position and an attitude of the sensor unit 10 will be described later. The position calculation portion 217 calculates a position of a predetermined portion of the golf club 3 at the time point t on the basis of a position and an attitude of the sensor unit 10 at the time point t.

Here, the predetermined portion of the golf club 3 is, for example, a predetermined portion of the head, the grip, or the shaft, an intermediate position between the grip end and the grip, and a central position of the golf club 3, or an attachment position of the sensor unit 10.

A position of the predetermined portion of the golf club 3 may be calculated on the basis of a positional relationship from an attachment position of the sensor unit 10 to the predetermined portion, a position of the sensor unit 10, and an attitude of the sensor unit 10.

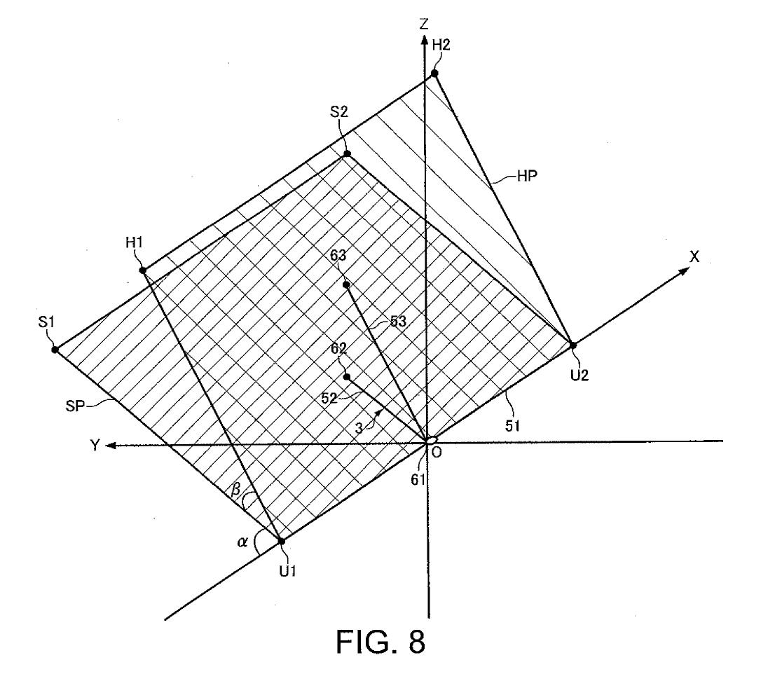

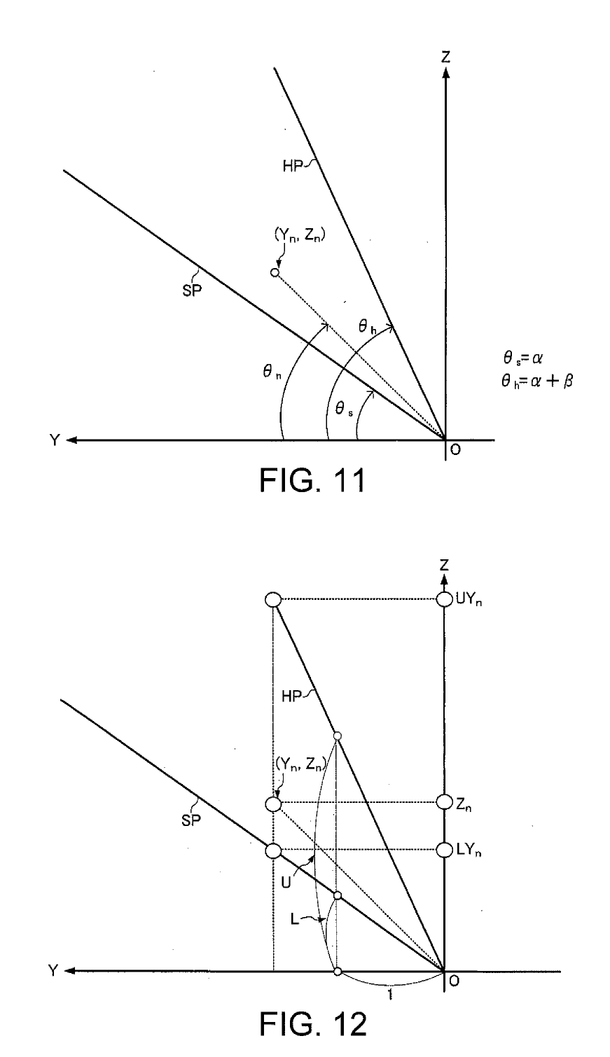

The V zone specifying portion 218 specifies a V zone (an example of a predetermined region) on the basis of measured data (acceleration data) output from the sensor unit 10 when the user 2 takes an address attitude. As illustrated in FIG. 8, the V zone is a region interposed between a shaft plane SP (an example of a first virtual plane) and a Hogan plane HP (an example of a second virtual plane). A method of specifying the V zone will be described later. FIG. 11 illustrates examples of the shaft plane SP and the Hogan plane HP in a plan view (on a YZ plane (an example of a predetermined plane)) from a reverse target direction of a right-handed user 2.

The keeping ratio calculation portion 2110 calculates a ratio (proportion) in which a position of a predetermined portion of the golf club 3 is included in the V zone within a predetermined period in which a V zone keeping ratio is calculated.

For example, the keeping ratio calculation portion 2110 divides time-series data (data of positions acquired in the sampling cycle Δt) of positions of the predetermined portion of the golf club 3 in the predetermined period into N (for example, N=128) sections.

The keeping ratio calculation portion 2110 calculates an average position (average angular position) in each section on the basis of time-series data for each section, as a position (angular position) in each section.

The keeping ratio calculation portion 2110 counts the number (keeping number) M included in the V zone among positions (angular positions) in the respective sections, and calculates a value R=M/N obtained by dividing the keeping number M by a total number N of the sections as a V zone keeping ratio R (an example of a ratio) in a predetermined period.

The keeping ratio calculation portion 2110 may use a representative position (representative angular position) in a section instead of using an average position (average angular position) in the section as a position in the section.

As mentioned above, if time-series data of a position is converted into data in each section, the number of data of a position is reduced so that it is possible to reduce a number of times for which the keeping determination portion 219 which will be described later performs determination (including a step of calculating an angular position θₙ in the present embodiment), and thus the conversion is efficient.

Here, if the keeping ratio calculation portion 2110 sets temporal lengths of a plurality of sections to be the same as each other, a ratio (temporal ratio) between a length of a predetermined period and time for which a predetermined portion is included in the V zone may be calculated as the V zone keeping ratio R. On the other hand, if the keeping ratio calculation portion 2110 sets spatial lengths of a plurality of sections to be the same as each other, a ratio (distance ratio) between a length of a trajectory of a predetermined portion in a predetermined period and a length of a trajectory of the predetermined portion included in a V zone may be calculated as the V zone keeping ratio R.

The keeping ratio calculation portion 2110 may calculate both of the V zone keeping ratio R as a temporal ratio and the V zone keeping ratio R as a distance ratio, and may calculate only one of the V zone keeping ratio R as a temporal ratio and the V zone keeping ratio R as a distance ratio.

The user 2 may designate one of a temporal ratio and a distance ratio as the type of V zone keeping ratio R to be calculated by the keeping ratio calculation portion 2110. The content designated by the user 2 is input to the swing analysis apparatus 20 via, for example, the operation section 23, and is recognized by the processing section 21.

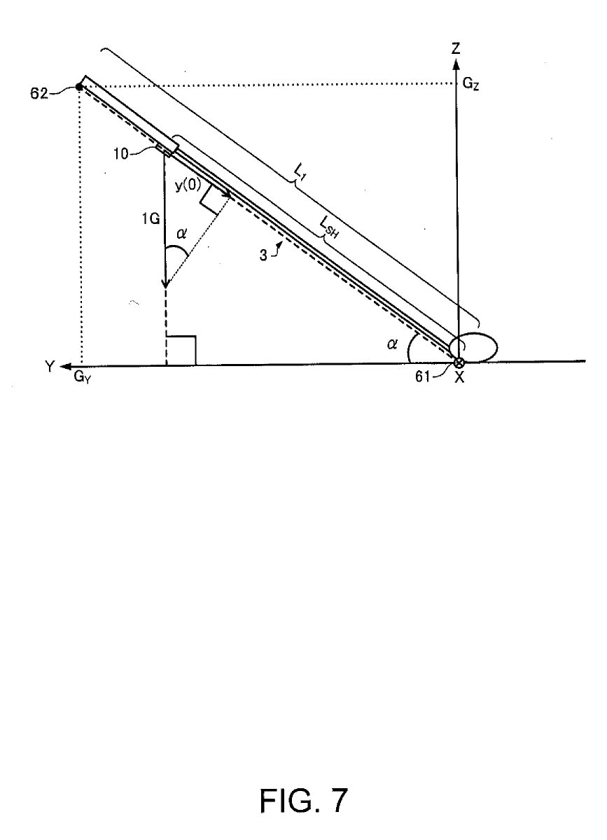

The keeping determination portion 219 determines whether or not a position of a predetermined portion is included in the V zone. For example, as illustrated in FIG. 11, the keeping determination portion 219 sets an angle θ formed between the shaft plane SP and a Y axis of the global coordinate system on the YZ plane as a first threshold value, and an angle θₕ formed between the Hogan plane HP and the Y axis of the global coordinate system on the YZ plane as a second threshold value. The angle θₛ in FIG. 11 corresponds to an inclined angle α in FIGS. 7 to 10, and the angle θₕ in FIG. 11 corresponds to an angle (α+β) in FIGS. 7 to 10.

As illustrated in FIG. 11, the keeping determination portion 219 calculates, as the angular position θₙ of the predetermined portion, an angle formed between a straight line connecting YZ coordinates (Yₙ, Zₙ) of a position to the origin of the global coordinate system and the Y axis in the YZ plane. The keeping determination portion 219 determines whether or not the angular position θₙ of the predetermined portion is included in an angle range (θₛ to θₕ) from the first threshold value θₛ to the second threshold value θₕ, determines that a position of the predetermined portion is included in the V zone (kept in the V zone) if the angular position is included in the angle range, and determines that a position of the predetermined portion was not included in the V zone (was not kept in the V zone) if the angular position is not included in the angle range. The example illustrated in FIG. 11 is an example of a case where the position of the predetermined portion is included in the V zone.

### 1-7. Setting of Global Coordinate System

As illustrated in FIG. 7, when a position of the head of the golf club 3 at address (during standing still) is set to the origin, the position calculation portion 217 defines an XYZ coordinate system (global coordinate system) which has a target line indicating a target hit ball direction as an X axis, an axis on a horizontal plane which is perpendicular to the X axis as a Y axis, and a vertically upward direction (a direction opposite to the gravitational acceleration direction) as a Z axis. In order to calculate each index value, the position calculation portion 217 calculates a position and an attitude of the sensor unit 10 in a time series from the time of the address in the XYZ coordinate system (global coordinate system) by using measured data (acceleration data and angular velocity data) in the sensor unit 10.

### 1-8. Calculation of Position and Attitude of Sensor Unit

If the user 2 performs the action in step S4 in FIG. 3, first, the position calculation portion 217 determines that the user 2 stands still at an address attitude in a case where an amount of changes in acceleration data measured by the acceleration sensor 12 does not continuously exceed a threshold value for a predetermined period of time. Next, the position calculation portion 217 computes an offset amount included in the measured data by using the measured data (acceleration data and angular velocity data) for the predetermined period of time. Next, the position calculation portion 217 subtracts the offset amount from the measured data so as to perform bias correction, and computes a position and an attitude of the sensor unit 10 during a swing action of the user 2 (during the action in step S6 in FIG. 3) by using the bias-corrected measured data.

Specifically, first, the position calculation portion 217 computes a position (initial position) of the sensor unit 10 during standing still (at address) of the user 2 in the XYZ coordinate system (global coordinate system) by using the acceleration data measured by the acceleration sensor 12, the golf club information 242, and the sensor attachment position information 246.

FIG. 7 is a plan view in which the golf club 3 and the sensor unit 10 during standing still (at address) of the user 2 are viewed from a negative side of the X axis. The origin O (0, 0, 0) is set at a position 61 of the head of the golf club 3, and coordinates of a position 62 of a grip end are (0, G_{Y}/G_{Z}). Since the user 2 performs the action in step S4 in FIG. 3, the position 62 of the grip end or the initial position of the sensor unit 10 has an X coordinate of 0, and is present on the YZ plane. As illustrated in FIG. 7, the gravitational acceleration of 1G is applied to the sensor unit 10 during standing still of the user 2, and thus a relationship between a y axis acceleration y(0) measured by the sensor unit 10 and an inclined angle (an angle formed between the long axis of the shaft and the horizontal plane (XY plane)) α of the shaft of the golf club 3 is expressed by Equation (1).

y(0)=1G·sin α (1)

Therefore, the position calculation portion 217 can calculate the inclined angle α according to Equation (1) by using any acceleration data between any time points at address (during standing still).

Next, the position calculation portion 217 subtracts a distance L_{SG} between the sensor unit 10 and the grip end included in the sensor attachment position information 246 from a length L₁ of the shaft included in the golf club information 242, so as to obtain a distance L_{SH} between the sensor unit 10 and the head. The position calculation portion 217 sets, as the initial position of the sensor unit 10, a position separated by the distance L_{SH} from the position 61 (origin O) of the head in a direction (a negative direction of the y axis of the sensor unit 10) specified by the inclined angle α of the shaft.

The position calculation portion 217 integrates subsequent acceleration data so as to compute coordinates of a position from the initial position of the sensor unit 10 in a time series.

The position calculation portion 217 computes an attitude (initial attitude) of the sensor unit 10 during standing still (at address) of the user 2 in the XYZ coordinate system (global coordinate system) by using acceleration data measured by the acceleration sensor 12. Since the user 2 performs the action in step S4 in FIG. 3, the x axis of the sensor unit 10 matches the X axis of the XYZ coordinate system in terms of direction at address (during standing still) of the user 2, and the y axis of the sensor unit 10 is present on the YZ plane. Therefore, the position calculation portion 217 can specify the initial attitude of the sensor unit 10 on the basis of the inclined angle α of the shaft of the golf club 3.

The position calculation portion 217 computes changes in attitudes from the initial attitude of the sensor unit 10 in a time-series manner by performing rotation calculation using angular velocity data which is subsequently measured by the angular velocity sensor 14. An attitude of the sensor unit 10 may be expressed by, for example, rotation angles (a roll angle, a pitch angle, and a yaw angle) about the X axis, the Y axis, and the Z axis, or a quaternion.

The signal processing section 16 of the sensor unit 10 may compute an offset amount of measured data so as to perform bias correction on the measured data, and the acceleration sensor 12 and the angular velocity sensor 14 may have a bias correction function. In this case, it is not necessary for the position calculation portion 217 to perform bias correction on the measured data.

### 1-9. Detection of Timings of Swing Starting, Top, and Impact

First, the timing detection portion 216 detects a timing (impact timing) at which the user 2 hit a ball by using measured data. For example, the timing detection portion 216 may compute a combined value of measured data (acceleration data or angular velocity data), and may detect an impact timing (time point) on the basis of the combined value.

Specifically, first, the timing detection portion 216 computes a combined value n₀ (t) of angular velocities at each time point t by using the angular velocity data (bias-corrected angular velocity data for each time point t). For example, if the angular velocity data items at the time point t are respectively indicated by x(t), y(t), and z(t), the timing detection portion 216 computes the combined value n₀ (t) of the angular velocities according to the following Equation (2).

n₀(t)=\sqrt{x(t)²+y(t)²+z(t)²} (2)

Next, the timing detection portion 216 converts the combined value n₀ (t) of the angular velocities at each time point t into a combined value n(t) which is normalized (scale-conversion) within a predetermined range. For example, if the maximum value of the combined value of the angular velocities in an acquisition period of measured data is max (n₀), the timing detection portion 216 converts the combined value n₀ (t) of the angular velocities into the combined value n(t) which is normalized within a range of 0 to 100 according to the following Equation (3).

$$n ( t ) = \frac{100 \times {n}_{0} ( t )}{max ( {n}_{0} )} \qquad ( 3 )$$

Next, the timing detection portion 216 computes a derivative dn(t) of the normalized combined value n (t) at each time point t. For example, if a cycle for measuring three-axis angular velocity data items is indicated by Δt, the timing detection portion 216 computes the derivative (difference) do (t) of the combined value of the angular velocities at the time point t by using the following Equation (4).

dn(t)=n(t)−n(t−Δt) (4)

Next, of time points at which a value of the derivative dn(t) of the combined value becomes the maximum and the minimum, the timing detection portion 216 specifies the earlier time point as an impact time point t_{impact} (impact timing). The timing detection portion 216 can capture a timing at which a derivative value of the combined value of the angular velocities is the maximum or the minimum (that is, a timing at which the derivative value of the combined value of the angular velocities is a positive maximum value or a negative minimum value) in a series of swing actions as the impact timing. Since the golf club 3 vibrates due to the impact, a timing at which a derivative value of the combined value of the angular velocities is the maximum and a timing at which a derivative value of the combined value of the angular velocities is the minimum may occur in pairs, and, of the two timings, the earlier timing may be the moment of the impact.

Next, the timing detection portion 216 specifies a time point of a minimum point at which the combined value n(t) is close to 0 before the impact time point t_{impact}, as a top time point tₜₒₚ (top timing). It is considered that, in a typical golf swing, an action temporarily stops at the top after starting the swing, then a swing speed increases, and finally impact occurs. Therefore, the timing detection portion 216 can capture a timing at which the combined value of the angular velocities is close to 0 and becomes the minimum before the impact timing, as the top timing.

Next, the timing detection portion 216 sets an interval in which the combined value n(t) is equal to or smaller than a predetermined threshold value before and after the top time point tₜₒₚ, as a top interval, and detects a last time point at which the combined value n(t) is equal to or smaller than the predetermined threshold value before a starting time point of the top interval, as a swing starting (backswing starting) time point tₛₜₐᵣₜ. It is hardly considered that, in a typical golf swing, a swing action is started from a standing still state, and the swing action is stopped till the top. Therefore, the timing detection portion 216 can capture the last timing at which the combined value of the angular velocities is equal to or smaller than the predetermined threshold value before the top interval as a timing of starting the swing action. The timing detection portion 216 may detect a time point of the minimum point at which the combined value n(t) is close to 0 before the top time point tₜₒₚ as the swing starting time point tₛₜₐᵣₜ.

The timing detection portion 216 may also detect each of a swing starting timing, a top timing, an impact timing by using three-axis acceleration data in the same manner.

### 1-10. Specifying of V Zone

In the present embodiment, it is expected that the V zone is displayed, and thus the V zone specifying portion 218 specifies not only the positions of the shaft plane SP and the Hogan plane HP forming the V zone but also sizes and shapes thereof. However, in a V zone keeping ratio calculation process which will be described later, a size and a shape of the shaft plane SP and a size and a shape of the Hogan plane HP are not taken into consideration. In a case where sizes and shapes are not taken into consideration, the shaft plane SP and the Hogan plane HP can be specified if an inclined angle α and a first angle β which will be described later can be specified.

The shaft plane SP is a first virtual plane specified by a target line (target hit ball direction) and the long axis direction of the shaft of the golf club 3 at address (standing still state) of the user 2 before starting a swing. The Hogan plane HP is a second virtual plane specified by a virtual line connecting the vicinity of the shoulder (the shoulder or the base of the neck) of the user 2 to the head of the golf club 3 (or the golf ball 4), and the target line (target hit ball direction), at address of the user 2.

FIG. 8 is a diagram illustrating the shaft plane SP and the Hogan plane HP. FIG. 8 displays the X axis, the Y axis, and the Z axis of the XYZ coordinate system (global coordinate system).

As illustrated in FIG. 8, in the present embodiment, a virtual plane which includes a first line segment 51 as a first axis along a target hit ball direction and a second line segment 52 as a second axis along the long axis direction of the shaft of the golf club 3, and has four vertices such as U1, U2, S1, and S2, is used as the shaft plane SP (first virtual plane). In the present embodiment, the position 61 of the head of the golf club 3 at address is set as the origin O (0, 0, 0) of the XYZ coordinate system, and the second line segment 52 is a line segment connecting the position 61 (origin O) of the head of the golf club 3 to the position 62 of the grip end. The first line segment 51 is a line segment having a length UL in which U1 and U2 on the X axis are both ends, and the origin O is a midpoint. Since the user 2 performs the action in step S4 in FIG. 3 at address, and thus the shaft of the golf club 3 is perpendicular to the target line (X axis), the first line segment 51 is a line segment orthogonal to the long axis direction of the shaft of the golf club 3, that is, the second line segment 52. The V zone specifying portion 218 calculates coordinates of the four vertices U1, U2, S1, and S2 of the shaft plane SP in the XYZ coordinate system.

Specifically, first, the V zone specifying portion 218 computes coordinates (0, G_{Y}, G_{X}) of the position 62 of the grip end of the golf club 3 by using the inclined angle α and the length L₁ of the shaft included in the golf club information 242. The V zone specifying portion 218 may compute G_{Y} and G_{Z} by using the length L₁ of the shaft and the inclined angle α according to Equations (5) and (6).

G_{Y}=L₁·cos α (5)

G_{Z}=L₁·sin α (6)

Next, the V zone specifying portion 218 multiplies the coordinates (0, G_{Y}, G_{Z}) of the position 62 of the grip end of the golf club 3 by a scale factor S so as to compute coordinates (0, S_{Y}, S_{Z}) of a midpoint S3 of the vertex S1 and the vertex S2 of the shaft plane SP. In other words, the V zone specifying portion 218 computes S_{Y} and S_{Z} according to Equations (7) and (8), respectively.

S_{Y}=G_{Y}·S (7)

S_{Z}=G_{Z}·S (8)

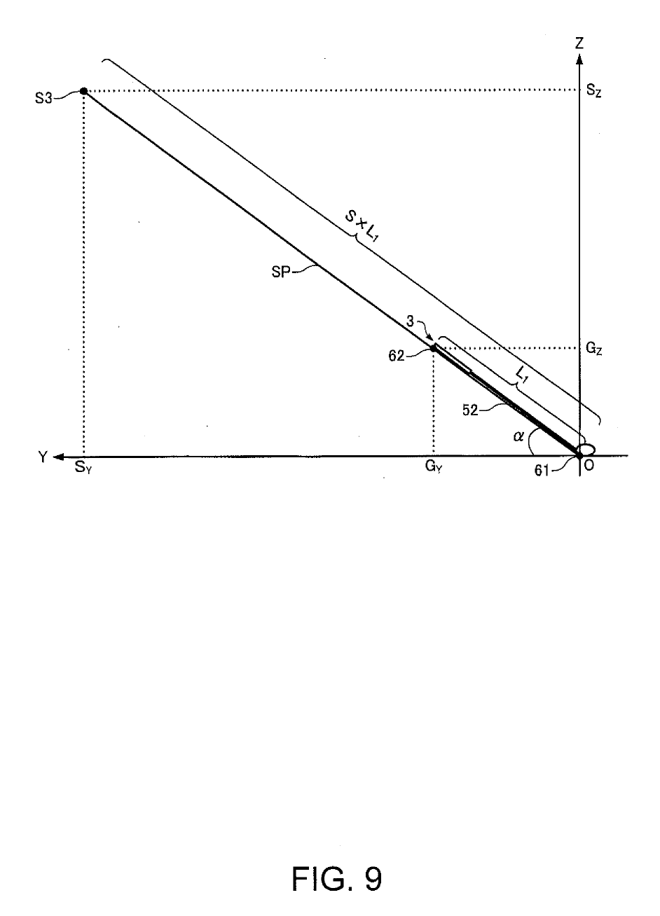

FIG. 9 is a view in which a sectional view of the shaft plane SP in FIG. 8 which is cut in the YZ plane is viewed from the negative side of the X axis. As illustrated in FIG. 9, a length (a width of the shaft plane SP in a direction orthogonal to the X axis) of a line segment connecting the midpoint S3 of the vertex S1 and the vertex S2 to the origin O is S times the length L₁ of the second line segment 52. For example, if a length of the arm of the user 2 is indicated by L₂, the scale factor S may be set as in Equation (9) so that the width S×L₁ of the shaft plane SP in the direction orthogonal to the X axis is twice the sum of the length L₁ of the shaft and the length L₂ of the arm.

$$S = \frac{2 \cdot ( {L}_{1} + {L}_{2} )}{{L}_{1}} \qquad ( 9 )$$

The length L₂ of the arm of the user 2 is associated with a height L₀ of the user 2. The length L₂ of the arm is expressed by a correlation expression such as Equation (10) in a case where the user 2 is a male, and is expressed by a correlation expression such as Equation (11) in a case where the user 2 is a female, on the basis of statistical information.

L₂=0.41×L₀−45.5 [mm] (10)

L₂=0.46×L₀−126.9 [mm] (11)

Therefore, the V zone specifying portion 218 may calculate the length L₂ of the arm of the user according to Equation (10) or Equation (11) by using the height L₀ and a sex of the user 2 included in the physical information 244.

Next, the V zone specifying portion 218 computes coordinates (−UL/2, 0, 0) of the vertex U1 of the shaft plane SP, coordinates (UL/2, 0, 0) of a vertex U2, coordinates (−UL/2, S_{Y}, S_{Z}) of the vertex S1, and coordinates (UL/2, S_{Y}, S_{Z}) of the vertex S2 by using the coordinates (0, S_{Y}, S_{Z}) of the midpoint S3 and a width (the length of the first line segment 51) UL of the shaft plane SP in the X axis direction. The width UL in the X axis direction is set to a value at which a trajectory of the golf club 3 during a swing action of the user 2 enters the shaft plane SP. For example, the width UL in the X axis direction may be set to be the same as the width S×L₁ in the direction orthogonal to the X axis, that is, twice the sum of the length L₁ of the shaft and the length L₂ of the arm.

In the above-described manner, the V zone specifying portion 218 can calculate the coordinates of the four vertices U1, U2, S1, and S2 of the shaft plane SP.

As illustrated in FIG. 8, in the present embodiment, a virtual plane which includes a first line segment 51 as a first axis and a third line segment 53 as a third axis, and has four vertices such as U1, U2, H1, and H2, is used as the Hogan plane HP (second virtual plane). The third line segment 53 is a line segment connecting a predetermined position 63 in the vicinity of a line segment connecting both of the shoulders of the user 2, to the position 61 of the head of the golf club 3. However, the third line segment 53 may be a line segment connecting the predetermined position 63 to a position of the golf ball 4. The V zone specifying portion 218 calculates respective coordinates of the four vertices U1, U2, H1, and H2 of the Hogan plane HP in the XYZ coordinate system.

Specifically, first, the V zone specifying portion 218 estimates the predetermined position 63 by using the coordinates (0, G_{Y}, G_{Z}) of the position 62 of the grip end of the golf club 3 at address (during standing still), and the length L₂ of the arm of the user 2 based on the physical information 244, and computes coordinates (A_{X}, A_{Y}, A_{Z}) thereof.

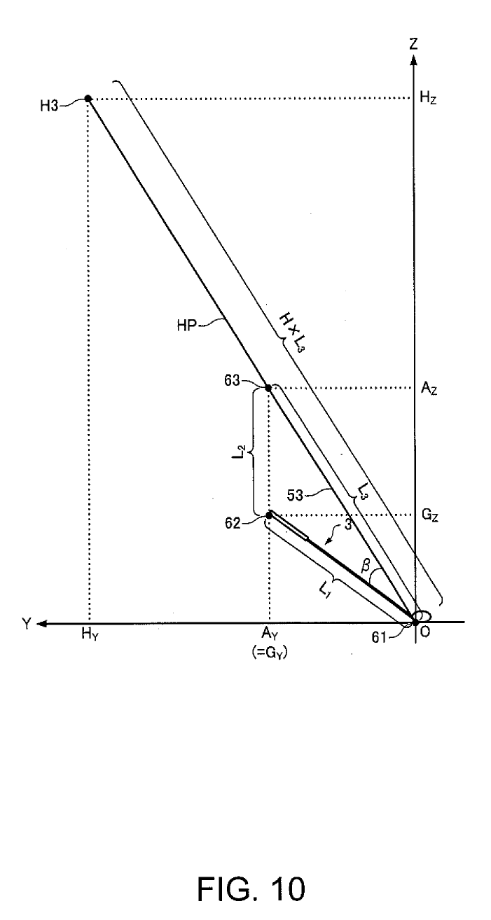

FIG. 10 is a view in which a sectional view of the Hogan plane HP in FIG. 8 which is cut in the YZ plane is viewed from the negative side of the X axis. In FIG. 10, a midpoint of the line segment connecting both of the shoulders of the user 2 is the predetermined position 63, and the predetermined position 63 is present on the YZ plane. Therefore, an X coordinate A_{X} of the predetermined position 63 is 0. As illustrated in FIG. 10, the V zone specifying portion 218 estimates, as the predetermined position 63, a position obtained by moving the position 62 of the grip end of the golf club 3 by the length L₂ of the arm of the user 2 in a positive direction along the Z axis. Therefore, the V zone specifying portion 218 sets a Y coordinate A_{Y} of the predetermined position 63 to be the same as the Y coordinate G_{Y} of the position 62 of the grip end. The V zone specifying portion 218 computes a Z coordinate A_{Z} of the predetermined position 63 as a sum of the Z coordinate G_{Z} of the position 62 of the grip end and the length L₂ of the arm of the user 2 as in Equation (12).

A_{Z}=G_{Z}+L₂ (12)

Next, the V zone specifying portion 218 multiplies the Y coordinate A_{Y} and the Z coordinate A_{Z} of the predetermined position 63 by a scale factor H, so as to compute coordinates (0, H_{Y}, H_{Z}) of a midpoint H3 of the vertex H1 and the vertex H2 of the Hogan plane HP. In other words, the V zone specifying portion 218 computes H_{Y} and H_{Z} according to Equation (13) and Equation (14), respectively.

H_{Y}=A_{Y}·H (13)

H_{Z}=A_{Z}·H (14)

As illustrated in FIG. 10, a length (a width of the Hogan plane HP in a direction orthogonal to the X axis) of a line segment connecting the midpoint H3 of the vertex H1 and the vertex H2 to the origin O is H times the length L₃ of the third line segment 53. For example, the Hogan plane HP may have the same shape and size as the shape and the size of the shaft plane SP. In this case, the width H×L₃ of the Hogan plane HP in the direction orthogonal to the X axis matches the width S×L₁ of the shaft plane SP in the direction orthogonal to the X axis, and is twice the sum of the length L₁ of the shaft of the golf club 3 and the length L₂ of the arm of the user 2. Therefore, the V zone specifying portion 218 may compute the scale factor H according to Equation (15).

$$H = \frac{2 \cdot ( {L}_{1} + {L}_{2} )}{{L}_{3}} \qquad ( 15 )$$

The V zone specifying portion 218 may compute the length L₃ of the third line segment 53 according to Equation (13) by using the Y coordinate A_{Y} and the Z coordinate A_{Z} of the predetermined position 63.

Next, the V zone specifying portion 218 computes coordinates (−UL/2, H_{Y}, H_{Z}) of the vertex H1 of the Hogan plane HP, and coordinates (UL/2, H_{Y}, H_{Z}) of the vertex H2 thereof by using the coordinates (0, H_{Y}, H_{Z}) of the midpoint H3 and a width (the length of the first line segment 51) UL of the Hogan plane HP in the X axis direction. The two vertices U1 and U2 of the Hogan plane HP are the same as those of the shaft plane SP, and thus the V zone specifying portion 218 does not need to compute coordinates of the vertices U1 and U2 of the Hogan plane HP again.

In the above-described manner, the V zone specifying portion 218 can calculate the coordinates of the four vertices U1, U2, H1, and H2 of the Hogan plane HP.

A region interposed between the shaft plane SP (first virtual plane) and the Hogan plane HP (second virtual plane) is referred to as the “V zone”.

In the present embodiment, as is clear from FIG. 10, the first angle β (an example of a predetermined angle) formed between the shaft plane SP and the Hogan plane HP is determined depending on the length L₁ of the shaft of the golf club 3 and the length L₂ of the arm of the user 2. In other words, since the first angle β is not a fixed value, and is determined depending on the type of golf club 3 or physical features of the user 2, the more appropriate shaft plane SP and Hogan plane HP (V zone) are calculated as an index for diagnosing a swing of the user 2.

However, in order to simply calculate the Hogan plane HP, the first angle β may be a fixed value. In this case, for example, the first angle β is set to any value within a range of 20° to 30° (the first angle β may be set to 20°, and may be set to 30°).

### 1-11. Display Screen of Swing Analysis Data

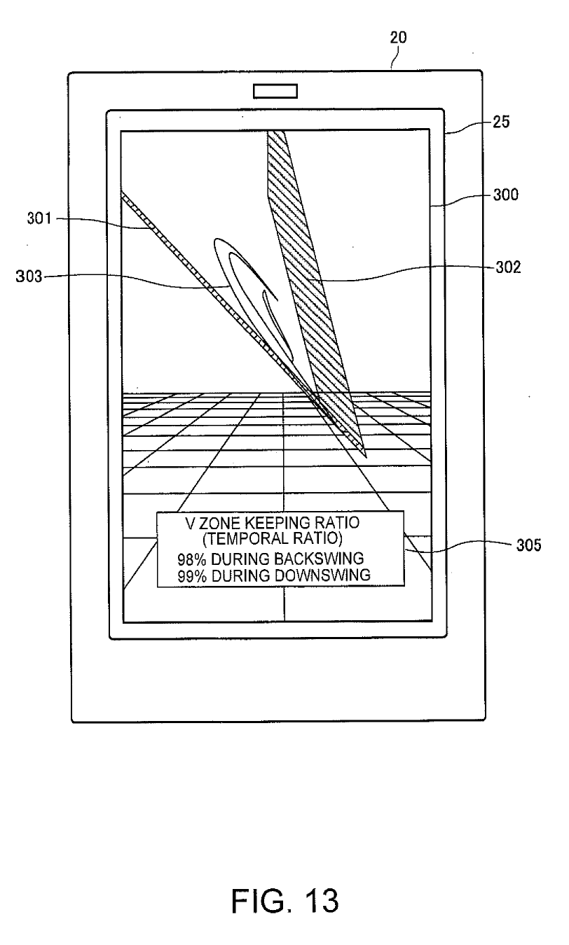

FIG. 13 illustrates an example of a display screen of swing analysis data displayed on the display section 25.

A display screen 300 includes a text image 305 displaying a V zone keeping ratio.

The text image 305 displays numerical values of the V zone keeping ratio in predetermined periods of a swing, and, the “predetermined periods” in the present embodiment are respectively the period of a backswing (from swing starting to a top) and the period of a downswing (from the top to impact) as described above.

Therefore, the text image 305 simultaneously displays, for example, a numerical value of the V zone keeping ratio during the backswing and a numerical value of the V zone keeping ratio during the downswing.

As mentioned above, if the V zone keeping ratio during the backswing and the V zone keeping ratio during the downswing are displayed on the display screen 300, the user 2 can compare the V zone keeping ratio during the backswing and the V zone keeping ratio during the downswing with each other.

The text image 305 also includes a display (a text image such as “temporal ratio” in FIG. 13) for identifying which one of the temporal ratio and the distance ratio is indicated by the currently displayed V zone keeping ratio.

The display screen 300 illustrated in FIG. 13 includes not only the text image 305 displaying the V zone keeping ratio but also a polygon 301 of the shaft plane indicating one boundary of the V zone, a polygon 302 of the Hogan plane indicating the other boundary of the V zone, and a trajectory image 303 of the golf club 3 during the swing.

Here, the trajectory image 303 is a trajectory image in the predetermined period during the swing, and is at least one of, for example, (1) a trajectory image in a period from swing starting to impact, (2) a trajectory image in a period of the downswing, (3) a trajectory image in a period of the backswing, (4) a trajectory image in a period from swing starting to halfway back, and (5) a trajectory image in a period from halfway down to impact.

However, a trajectory image which is displayed on the display screen 300 along with the text image 305 is preferably a trajectory image in a predetermined period in which a V zone keeping ratio is calculated. Therefore, in the present embodiment, trajectory images displayed on the display screen 300 along with the text image 305 are preferably respectively a trajectory image in the period of the backswing and a trajectory image in the period of the downswing.

The trajectory image 303 is a trajectory image of a predetermined portion of the golf club 3, and is at least one of, for example, a trajectory image of a line segment connecting the head and the grip of the golf club 3 to each other, a trajectory image of the head of the golf club 3, and a trajectory image of the grip of the golf club 3.

However, a trajectory image displayed on the display screen 300 along with the text image 305 is preferably a trajectory image of a predetermined portion for calculating a V zone keeping ratio.

As illustrated in FIG. 13, if the V zone and the trajectory image are displayed along with the V zone keeping ratio, the user 2 cannot only recognize the extent of the V zone keeping ratio as a numerical value but also visually recognize the extent thereof.

The display screen 300 illustrated in FIG. 13 may be a still image, and may be a moving image. A viewpoint of the display screen 300 may be switched through an operation performed by the user 2. A viewpoint of the display screen 300 is switched between at least two of, for example, a top view, a side view, a back view, and a front view.

The trajectory image 303 illustrated in FIG. 13 is a consecutive curve, but may be an image in which time-series data of positions of a predetermined portion is plotted as discrete points.

### 1-12. Flow of Swing Analysis Process

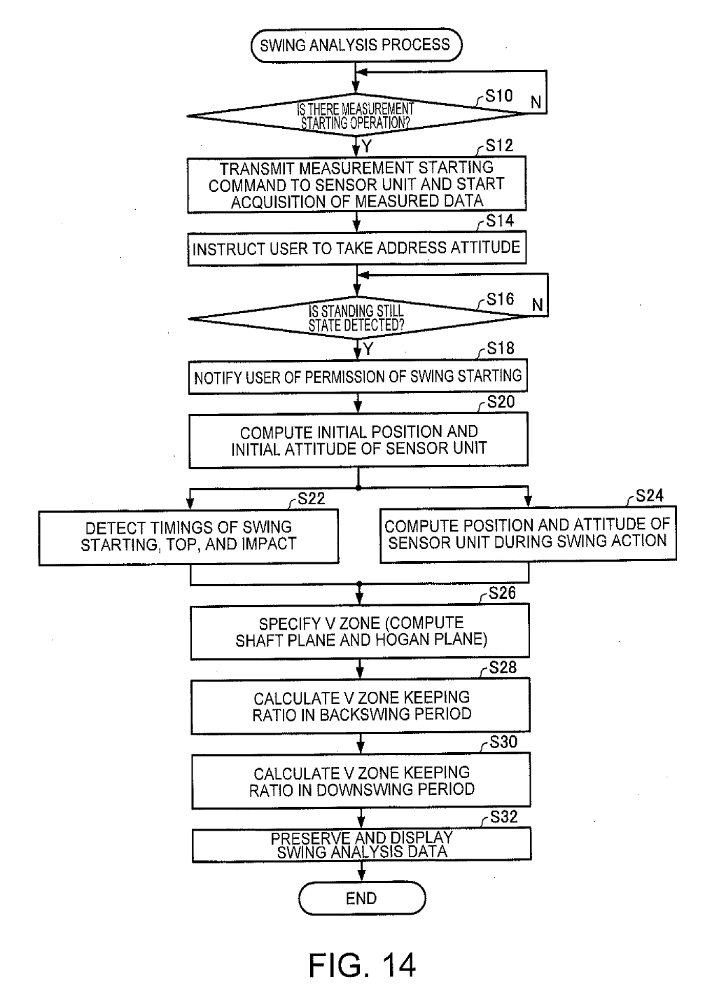

FIG. 14 is a flowchart illustrating examples of procedures of a swing analysis process (an example of a method) performed by the processing section 21. The processing section 21 performs the swing analysis process, for example, according to the procedures shown in the flowchart of FIG. 14 by executing the swing analysis program 240 stored in the storage section 24. Hereinafter, the flowchart of FIG. 14 will be described.

Step S10: The processing section 21 waits for the user 2 to perform a measurement starting operation (N in S10), and proceeds to the next step S12 if the measurement starting operation is performed (Y in S10).

Step S12: The processing section 21 transmits a measurement starting command to the sensor unit 10, and starts to acquire measured data from the sensor unit 10.

Step S14: The processing section 21 instructs the user 2 to take an address attitude. The user 2 takes the address attitude in response to the instruction, and stands still.

Step S16: The processing section 21 waits for a standing still state of the user 2 to be detected by using the measured data acquired from the sensor unit 10 (N in S16), and proceeds to step S18 if the standing still state is detected (Y in S16).

Step S18: The processing section 21 notifies the user 2 of permission of swing starting. The processing section 21 outputs, for example, a predetermined sound, or an LED is provided in the sensor unit 10, and the LED is lighted, so that the user 2 is notified of permission of swing starting. The user 2 confirms the notification and then starts a swing action. The processing section 21 performs processes in step S20 and subsequent steps after completion of the swing action of the user 2, or from before completion of the swing action.

Step S20: The processing section 21 computes an initial position and an initial attitude of the sensor unit 10 by using the measured data (measured data during standing still (at address) of the user 2) acquired from the sensor unit 10.

Step S22: The processing section 21 detects a swing starting timing, a top timing, and an impact timing by using the measured data acquired from the sensor unit 10.

Step S24: The processing section 21 computes a position and an attitude of the sensor unit 10 during the swing action of the user 2 in parallel to the process in step S22, or before and after the process in step S22. In step S24 of the present embodiment, a position of a predetermined portion for calculating a V zone keeping ratio is also computed.

Step S26: The processing section 21 specifies the V zone (the shaft plane SP and the Hogan plane HP) by using the measured data (measured data during standing still (at address) of the user 2) acquired from the sensor unit 10.

Step S28: The processing section 21 calculates a V zone keeping ratio in a period of the backswing. A method (V zone keeping ratio calculation process) of calculating the V zone keeping ratio in a predetermined period will be described later.

Step S30: The processing section 21 calculates a V zone keeping ratio in a period of the downswing. A method (V zone keeping ratio calculation process) of calculating the V zone keeping ratio in a predetermined period will be described later.

Step S32: The processing section 21 preserves and displays swing analysis data including the V zone keeping ratios calculated in steps S28 and S30. The processing section 21 finishes the flow of the swing analysis process.

In the flowchart of FIG. 14, order of the respective steps may be changed as appropriate within an allowable range, some of the steps may be omitted or changed, and other steps may be added thereto.

### 1-13. Flow of V Zone Keeping Ratio Calculation Process

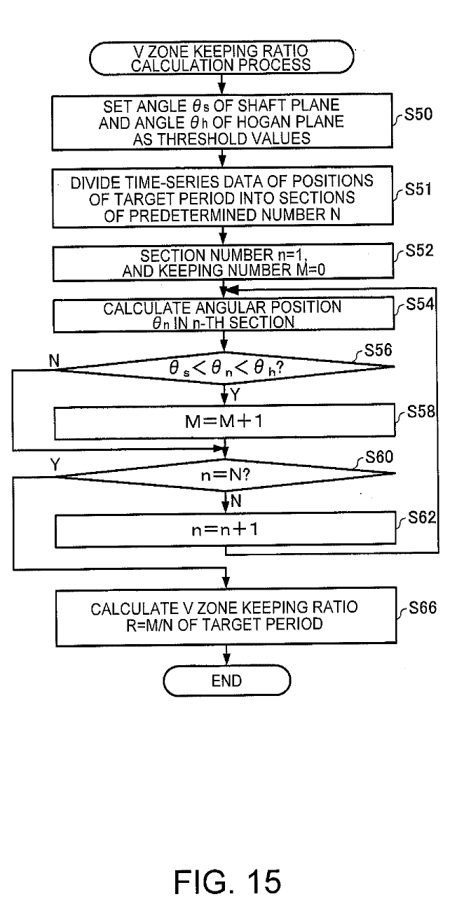

FIG. 15 is a flowchart illustrating examples of procedures of the V zone keeping ratio calculation process (an example of a method) performed by the processing section 21. The processing section 21 performs the V zone keeping ratio calculation process, for example, according to the procedures shown in the flowchart of FIG. 15 by executing the V zone keeping ratio calculation program 249 stored in the storage section 24. Hereinafter, the flowchart of FIG. 15 will be described.

Step S50: The processing section 21 sets the angle θₛ of the shaft plane SP as a first threshold value, and sets the angle θₕ of the Hogan plane HP as a second threshold value. The processing section 21 skips this step in a case where the first threshold value and the second threshold value have already been set.

Step S51: The processing section 21 divides time-series data indicating positions of a predetermined portion in a target period (predetermined period) into sections of a predetermined number N.

Step S52: The processing section 21 sets a section number n to 1, and sets a keeping number M to an initial value of zero.

Step S54: The processing section 21 calculates an angular position θₙ in an n-th section of the N sections.

Step S56: The processing section 21 determines whether or not the angular position θₙ is included in a range from the first threshold value θₙ to the second threshold value θₕ, and proceeds to step S58 if the angular position is included in the range, and proceeds to step S60 if the angular position is not included in the range.

Step S58: The processing section 21 increases the keeping number M by 1, and proceeds to step S60.

Step S60: The processing section 21 determines whether or not the section number n reaches a total number N of the sections, proceeds to step S62 if the section number n does not reach the total number N of the sections, and proceeds to step S66 if the section number n reaches the total number N of the sections.

Step S62: The processing section 21 increases the section number n by 1, and proceeds to step S54.

Step S66: A V zone keeping ratio R in the target period (predetermined period) is calculated according to R=M/N, and the flow is finished.

### 2. Second Embodiment

Hereinafter, a second embodiment will be described. Here, differences from the first embodiment will be focused, and the same constituent elements as those in the first embodiment are given the same reference numerals.

### 2-1. Principal Difference

A principal difference from the first embodiment is an operation of the processing section 21, particularly, operations of the timing detection portion 216, the swing analysis portion 211, and the keeping ratio calculation portion 2110.

The timing detection portion 216 of the present embodiment detects a halfway back timing and a halfway down timing in addition to a swing starting timing, a top timing, and an impact timing. A method of detecting the halfway back timing and the halfway down timing will be described later.

The swing analysis portion 211 of the present embodiment causes the keeping ratio calculation portion 2110 to calculate V zone keeping ratios including a V zone keeping ratio in a period from swing starting to halfway back and a V zone keeping ratio in a period from halfway down to impact.

The keeping ratio calculation portion 2110 of the present embodiment may divide time-series data of positions of a predetermined portion in a predetermined period into sections in the same manner as the keeping ratio calculation portion 2110 of the first embodiment, but is here assumed to calculate a V zone keeping ratio without dividing time-series data into sections since a predetermined period is shorter than in the first embodiment, and thus there is a high probability that the number of samples (the number of data regarding positions) is small.

For example, in a case where a period length of a backswing is 1500 msec, a period length of a downswing is 500 msec, and a sampling frequency is 1000 Hz, the number of samples of positions during the backswing is 1500, and the number of samples of positions during the downswing is 500. Therefore, the number of samples of positions in the period from the swing starting to the halfway back may be smaller than 1500, and the number of samples in the period from the halfway down to the impact may be smaller than 500.

The keeping ratio calculation portion 2110 of the present embodiment specifies the number N of samples of positions of a predetermined portion of the golf club 3 in a predetermined period in which a V zone keeping ratio is calculated, counts the number (keeping number) M of positions included in the V zone among the N positions, and calculates a value R=M/N obtained by dividing the keeping number M by the number N of samples as a V zone keeping ratio R in the predetermined period. In this case, a ratio (temporal ratio) between a length of the predetermined period and time for which the predetermined portion is included in the V zone is calculated as the V zone keeping ratio R.

### 2-2. Detection of Halfway Back and Halfway Down

First, the position calculation portion 217 computes a position of the head and a position of the grip end at each time point t by using the position and the attitude of the sensor unit 10 at each time point t from the swing start time point tₛₜₐᵣₜ to the impact time point t_{impact}.

Specifically, the position calculation portion 217 uses, as a position of the head, a position separated by the distance L_{SH} in the positive direction of the y axis specified by the attitude of the sensor unit 10, from the position of the sensor unit 10 at each time point t, and computes coordinates of the position of the head. As described above, the distance L_{SH} is a distance between the sensor unit 10 and the head. The position calculation portion 217 uses, as a position of the grip end, a position separated by the distance L_{SG} in the negative direction of the y axis specified by the attitude of the sensor unit 10, from the position of the sensor unit 10 at each time point t, and computes coordinates of the position of the grip end. As described above, the distance L_{SG} is a distance between the sensor unit 10 and the grip end.

Next, the position calculation portion 217 detects a halfway back timing and a halfway down timing by using the coordinates of the position of the head and the coordinates of the position of the grip end.

Specifically, the position calculation portion 217 computes a difference ΔZ between a Z coordinate of the position of the head and a Z coordinate of the position of the grip end at each time point t from the swing start time point tₛₜₐᵣₜ to the impact time point t_{impact}. The position calculation portion 217 detects a time point t_{HWB} at which a sign of ΔZ is inverted between the swing start time point tₛₜₐᵣₜ and the top time point tₜₒₚ, as the halfway back timing. The position calculation portion 217 detects a time point t_{HWB} at which a sign of ΔZ is inverted between the top time point tₜₒₚ and the impact time point t_{impact}, as the halfway down timing.

### 2-3. Flow of Swing Analysis Process

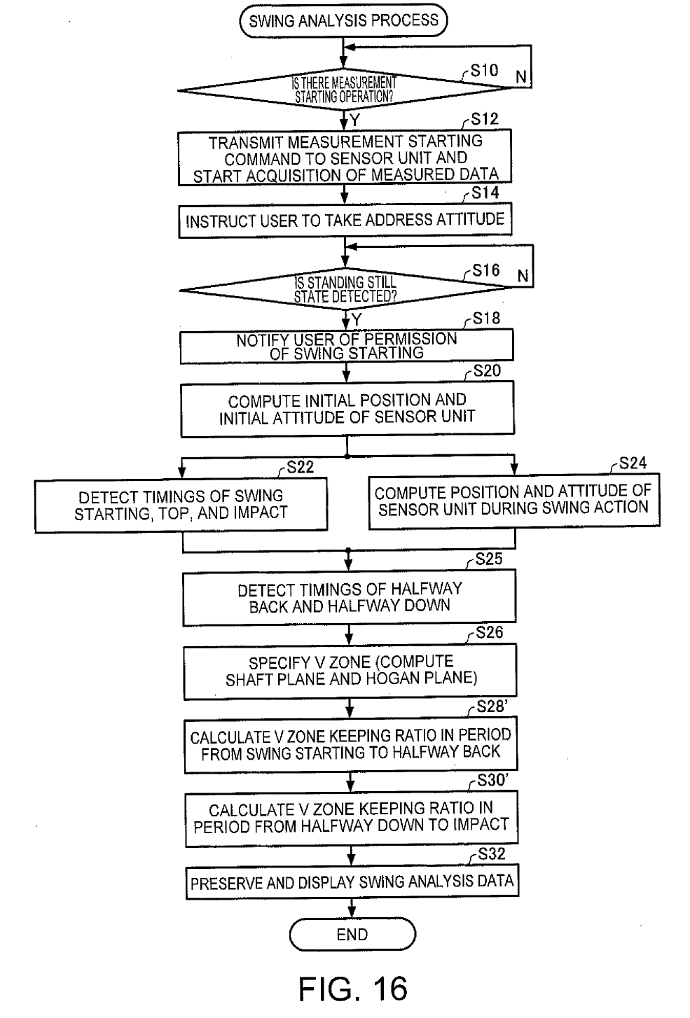

FIG. 16 is a flowchart illustrating examples of procedures of a swing analysis process (an example of a method) performed by the processing section 21 of the present embodiment. The processing section 21 performs the swing analysis process, for example, according to the procedures shown in the flowchart of FIG. 16 by executing the swing analysis program 240 stored in the storage section 24.

In the flowchart of FIG. 16, step S25 is executed between step S24 and step S26, and steps S28′ and S30′ are executed instead of steps S28 and S30 in the flowchart of FIG. 14. Hereinafter, steps S25, S28′ and S30′ will be described.

Step S25: The processing section 21 detects each of a halfway back timing and a halfway down timing.

Step S28′: The processing section 21 calculates a V zone keeping ratio in a period from swing starting to the halfway back. A method (V zone keeping ratio calculation process) of calculating the V zone keeping ratio in a predetermined period will be described later.

Step S30′: The processing section 21 calculates a V zone keeping ratio in a period from the halfway down to impact. A method (V zone keeping ratio calculation process) of calculating the V zone keeping ratio in a predetermined period will be described later.

In the flowchart of FIG. 16, order of the respective steps may be changed as appropriate within an allowable range, some of the steps may be omitted or changed, and other steps may be added thereto.

### 2-4. V Zone Keeping Ratio Calculation Process

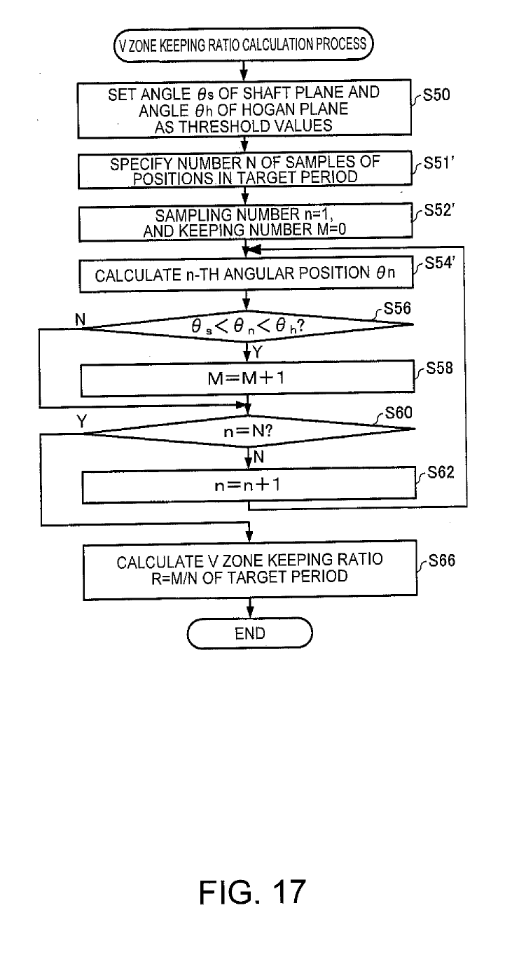

FIG. 17 is a flowchart illustrating examples of procedures of the V zone keeping ratio calculation process (an example of a method) performed by the processing section 21. The processing section 21 performs the V zone keeping ratio calculation process, for example, according to the procedures shown in the flowchart of FIG. 17 by executing the V zone keeping ratio calculation program 249 stored in the storage section 24.

In the flowchart of FIG. 17, steps S51′, S52′ and S54′ are executed instead of steps S51, S52 and S54 in the flowchart of FIG. 15. Hereinafter, the flowchart of FIG. 17 will be described.

Step S50: The processing section 21 sets the angle θₛ of the shaft plane SP as a first threshold value, and sets the angle θₕ of the Hogan plane HP as a second threshold value. The processing section 21 skips this step in a case where the first threshold value and the second threshold value have already been calculated.

Step S51′: The processing section 21 specifies the number N of samples of positions of a predetermined portion in a target period (predetermined period).

Step S52′: The processing section 21 sets a sampling number n to 1, and sets a keeping number M to an initial value of zero.

Step S54′: The processing section 21 calculates an angular position θₙ of an n-th position of the N positions.

Step S56: The processing section 21 determines whether or not the angular position θₙ is included in a range from the first threshold value θs to the second threshold value θh, and proceeds to step S58 if the angular position is included in the range, and proceeds to step S60 if the angular position is not included in the range.

Step S58: The processing section 21 increases the keeping number M by 1.

Step S60: The processing section 21 determines whether or not the sampling number n reaches the number N of samples, proceeds to step S62 if the sampling number n does not reach the number N of samples, and proceeds to step S66 if the sampling number n reaches the number N of samples.

Step S62: The processing section 21 increases the sampling number n by 1, and proceeds to step S54′.

Step S66: A V zone keeping ratio R in the target period (predetermined period) is calculated according to R=M/N, and the flow is finished.

### 3. Third Embodiment

Hereinafter, a third embodiment will be described. Here, differences from the first embodiment will be focused, and the same constituent elements as those in the first embodiment are given the same reference numerals. The third embodiment is a modification example of the first embodiment, but the second embodiment may also be similarly modified.

### 3-1. Principal Difference

A principal difference from the first embodiment is an operation of the processing section 21, particularly, an operation of the keeping determination portion 219.

As illustrated in FIG. 12, the keeping determination portion 219 of the present embodiment sets an inclination L of the shaft plane SP in the YZ plane of the global coordinate system as a first threshold coefficient, and sets an inclination U of the Hogan plane HP in the YZ plane of the global coordinate system as a second threshold coefficient.

Here, the inclination L is a coefficient L when an intersection line of the YZ plane and the shaft plane SP is expressed by an equation of Z=L×Y, and the inclination U is a coefficient U when an intersection line of the YZ plane and the Hogan plane HP is expressed by an equation of Z=U×Y.

The keeping determination portion 219 sets LYₙ obtained by multiplying the coefficient L by a Y coordinate Yₙ of a position of a predetermined portion as a first threshold value, and sets UYₙ obtained by multiplying the coefficient U by the Y coordinate Yₙ of the position of the predetermined portion as the second threshold value. The keeping determination portion 219 determines whether or not a Z coordinate Zₙ of the position of the predetermined portion is included in the range LYₙ to UYₙ from the first threshold value LYₙ to the second threshold value UYₙ, and determines that the position of the predetermined portion is included in the V zone (kept in the V zone) if the position is included in the range, and determines that the position of the predetermined portion is not included in the V zone (not kept in the V zone) if the position is not included in the range.

The above determination can be performed through only multiplication and magnitude comparison, and thus a trigonometric function (a tan function or the like) is not required to be used. Therefore, in the present embodiment, it is possible to reduce a calculation amount required in determination in the keeping determination portion 219.

### 3-2. V Zone Keeping Ratio Calculation Process

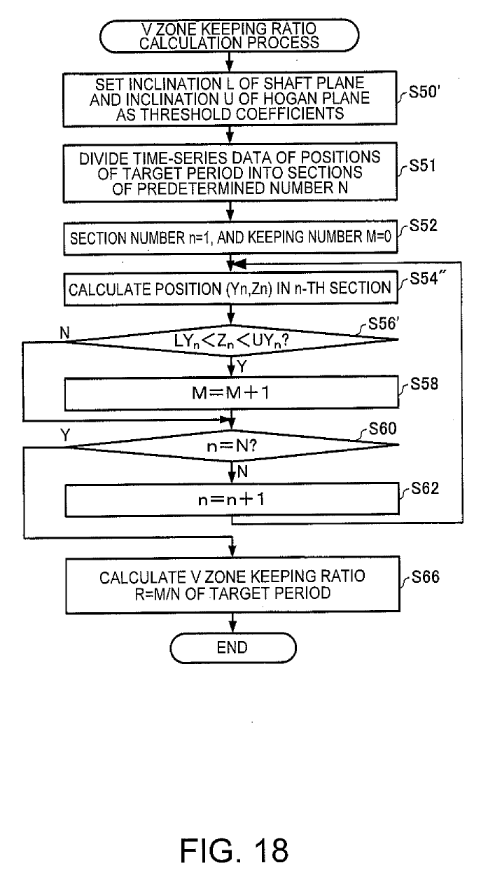

FIG. 18 is a flowchart illustrating examples of procedures of the V zone keeping ratio calculation process (an example of a method) performed by the processing section 21. The processing section 21 performs the V zone keeping ratio calculation process, for example, according to the procedures shown in the flowchart of FIG. 18 by executing the V zone keeping ratio calculation program 249 stored in the storage section 24.

In the flowchart of FIG. 18, steps S50′, S54″ and S56′ are executed instead of steps S50, S54 and S56 in the flowchart of FIG. 15. Hereinafter, the flowchart of FIG. 18 will be described.

Step S50′: The processing section 21 sets the inclination L of the shaft plane SP as a first threshold coefficient, and sets the inclination U of the Hogan plane HP as a second threshold coefficient. The processing section 21 skips this step in a case where the first threshold coefficient and the second threshold coefficient have already been calculated.

Step S51: The processing section 21 divides time-series data indicating positions of a predetermined portion in a target period (predetermined period) into sections of a predetermined number N.

Step S52: The processing section 21 sets a section number n to 1, and sets a keeping number M to an initial value of zero.

Step S54″: The processing section 21 calculates a position (Yₙ, Zₙ) of an n-th section of the N sections.

Step S56′: The processing section 21 determines whether or not the Z coordinate Zₙ of the position is included in a range from the first threshold value LYₙ to the second threshold value UYₙ, and proceeds to step S58 if the position is included in the range, and proceeds to step S60 if the position is not included in the range.

Step S58: The processing section 21 increases the keeping number M by 1.

Step S60: The processing section 21 determines whether or not the section number n reaches a total number N of the sections, proceeds to step S62 if the section number n does not reach the total number N of the sections, and proceeds to step S66 if the section number n reaches the total number N of the sections.

Step S62: The processing section 21 increases the section number n by 1, and proceeds to step S54″.

Step S66: A V zone keeping ratio R in the target period (predetermined period) is calculated according to R=M/N, and the flow is finished.

### 4. Appendix of Embodiments

### 4-1. Modification Examples of V Zone

In any one of the above-described embodiments, a predetermined region is a region interposed between a first plane along the longitudinal direction of the golf club 3 and a second plane passing through the vicinity of the shoulder of the user 2. The first plane is, for example, a so-called shaft plane which is specified by a first axis along a target hit ball direction, and a second axis along the longitudinal direction of the golf club 3 before starting the swing. The second plane is, for example, a so-called Hogan plane which includes the first axis and forms a predetermined angle with the first plane. However, the second plane may be a so-called shoulder plane which is parallel to the first plane (here, the “parallel plane” includes both a plane parallel to the first plane and a plane along the first plane).

In the above-described embodiments, the second plane may be calculated on the basis of both of the first plane and physical information of the user 2, and a plane having a predetermined relationship with the first plane may be the second plane.

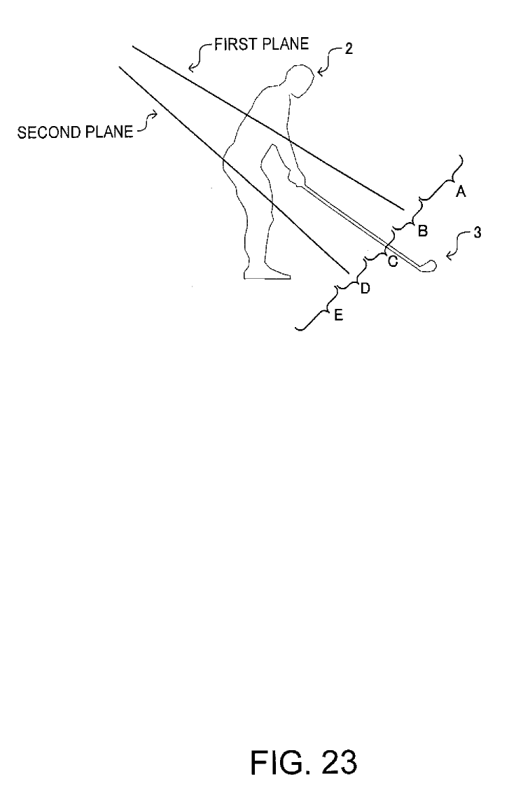

A method of defining the first plane and the second plane is not limited thereto, and, for example, planes as illustrated in FIG. 23 may be used. Two planes illustrated in FIG. 23 are planes which are set on the basis of an attitude of the shaft before starting a swing, in which a first plane is a virtual plane passing through the vicinity of the knee of the user 2, and a second plane is a virtual plane passing through the vicinity of the elbow of the user. The first plane and the second plane are not parallel to each other, and intersect each other on a straight line extending in a grip end direction of the golf club, for example.

### 4-2. Modification Examples of Predetermined Portion

In any one of the above-described embodiments, a predetermined portion for calculating a V zone keeping ratio may be the head of the golf club 3, may be the grip of the golf club 3, may be an intermediate position between the grip end and the grip, and may be other predetermined portions. The user 2 may designate any portion.

### 4-3. Modification Examples of Index

In any one of the above-described embodiments, swing analysis data may include indexes other than the V zone keeping ratio. In any one of the above-described embodiments, a ratio (1-R) deviated relative to the V zone may be calculated or presented instead of the V zone keeping ratio R.

In the second embodiment, one of predetermined periods for calculating a V zone keeping ratio is a period from swing starting to halfway back, but an end of the predetermined period may be set to a timing earlier than the halfway back so that the predetermined period is reduced.

In the second embodiment, one of predetermined periods for calculating a V zone keeping ratio is a period from halfway down to impact, but a start of the predetermined period may be set to a timing later than the halfway down so that the predetermined period is reduced.

In any one of the above-described embodiments, one of predetermined periods for calculating a V zone keeping ratio may be other periods during a swing. For example, the other periods may be a short period in the vicinity of a top, a short period right before impact, and a short period right after swing starting.

In the swing analysis apparatus 20 of the first embodiment, predetermined periods for calculating a V zone keeping ratio may be set to be the same as periods for calculating a V zone keeping ratio in the swing analysis apparatus 20 of the second embodiment.

In the swing analysis apparatus 20 of the second embodiment, predetermined periods for calculating a V zone keeping ratio may be set to be the same as periods for calculating a V zone keeping ratio in the swing analysis apparatus 20 of the first embodiment.

The swing analysis apparatus 20 of any one of the above-described embodiments calculates and presents a ratio between time for which a predetermined portion of the golf club is included in a predetermined region in a predetermined period of a swing and the predetermined period, but may calculate and present a ratio between time for which the predetermined portion of the golf club is included in the predetermined region and time for which the predetermined portion is not included in the predetermined region. The ratio may use the time for which the predetermined portion is included in the predetermined region as a reference, and may use the time for which the predetermined portion is not included in the predetermined region as a reference.

The swing analysis apparatus 20 of any one of the above-described embodiments calculates and presents a ratio between a length of a trajectory drawn by a predetermined portion of the golf club in a predetermined region and the entire length of the trajectory drawn in a predetermined period within the predetermined period of a swing, but may calculate and present a ratio between a length of a trajectory drawn in a predetermined region in a predetermined period and a length of a trajectory drawn in regions other than the predetermined region in the predetermined period. A reference of the ratio may be the length of the trajectory drawn in the predetermined region, and may be the length of the trajectory drawn in regions other than the predetermined region.

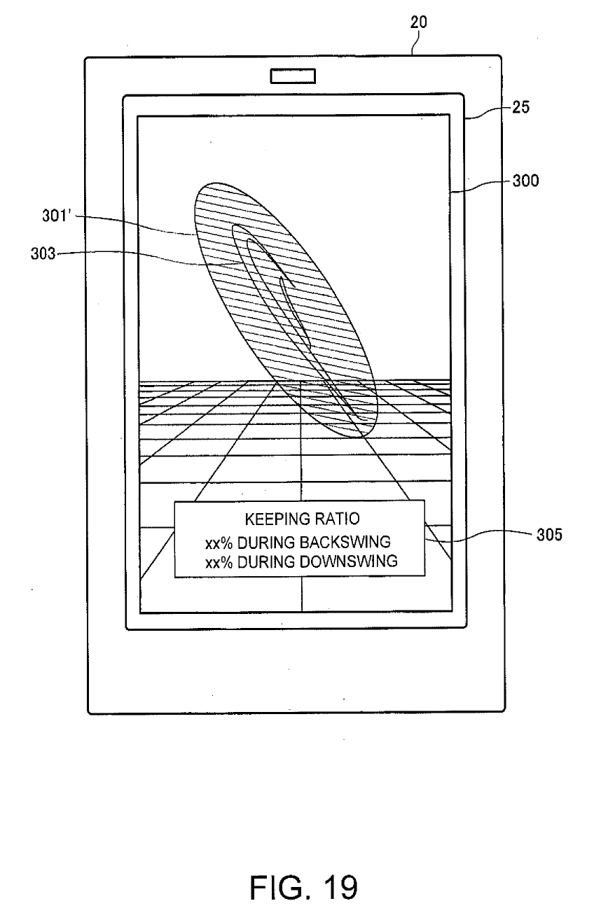

In the swing analysis apparatus 20 of any one of the above-described embodiments, a shape of a boundary of a predetermined region is a plane, but at least a part of the shape of the boundary may be a curved surface. In other words, the predetermined region may be a region surrounded by curved surfaces. FIG. 19 illustrates an example in which a predetermined region is the inside of an ellipsoid. The predetermined region may be a region surrounded by a spherical shell, and may be a region surrounded by other curved surfaces.

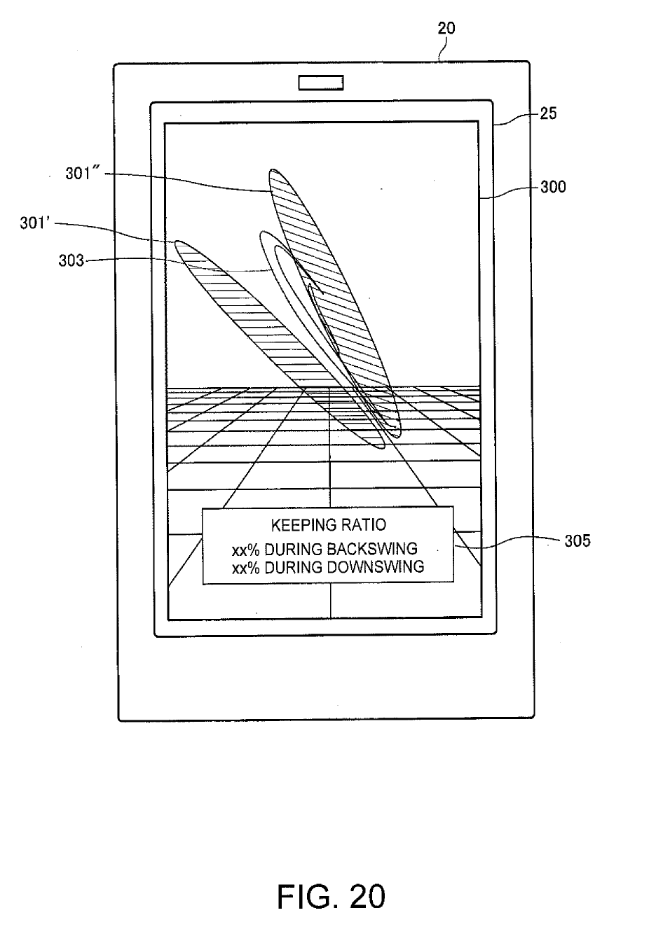

In the swing analysis apparatus 20 of any one of the above-described embodiments, a predetermined region is a single region, but may be a plurality of regions. FIG. 20 illustrates examples of two predetermined regions 301′ and 301″. In the examples illustrated in FIG. 20, each of the two predetermined regions 301′ and 301″ is a region of the inside of an ellipsoid. In this case, the swing analysis apparatus 20 may calculate and present a ratio for each predetermined region. Each of a plurality of predetermined regions may be set by the swing analysis apparatus 20, for example, on the basis of an attitude at address of a user, and may be designated in advance by the user.

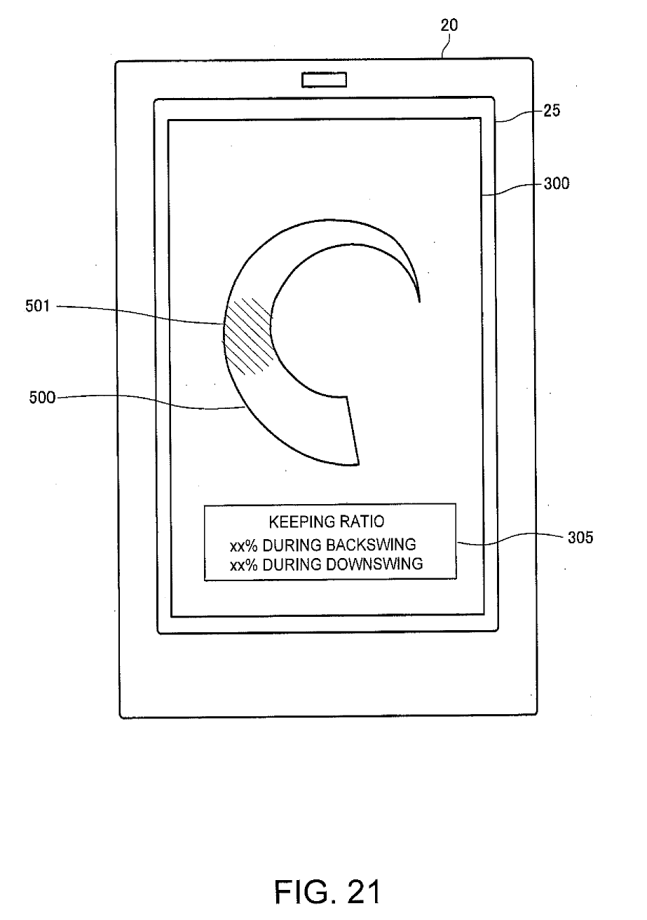

The swing analysis apparatus 20 of any one of the above-described embodiments may display a trajectory of a predetermined portion of the golf club, and may differentiate a portion of the trajectory included in a predetermined region and a portion thereof not included in the predetermined region on a screen. FIG. 21 illustrates an example in which a trajectory (a partially annular belt-shaped swing plane 500) of the shaft of the golf club, and a hatched pattern is added to a partial region 501 included in a predetermined region in the swing plane 500. A method of differentiating the partial region 501 is not limited to the method using the hatched pattern, and may employ various methods such as a method using density (gradation), a method using a color, and a method using a blinking pattern.

The swing analysis apparatus 20 may calculate and present at least one of the following indexes (1) to (6) regarding the swing plane 500.

(1) A ratio between an area of the swing plane 500 and an area of the partial region 501

(2) A ratio between an area of the partial region 501 in the swing plane 500 and an area of regions other than the partial region 501 in the swing plane 500

(3) A ratio (1) in a backswing

(4) A ratio (2) in a backswing

(5) A ratio (1) in a downswing

(6) A ratio (2) in a downswing

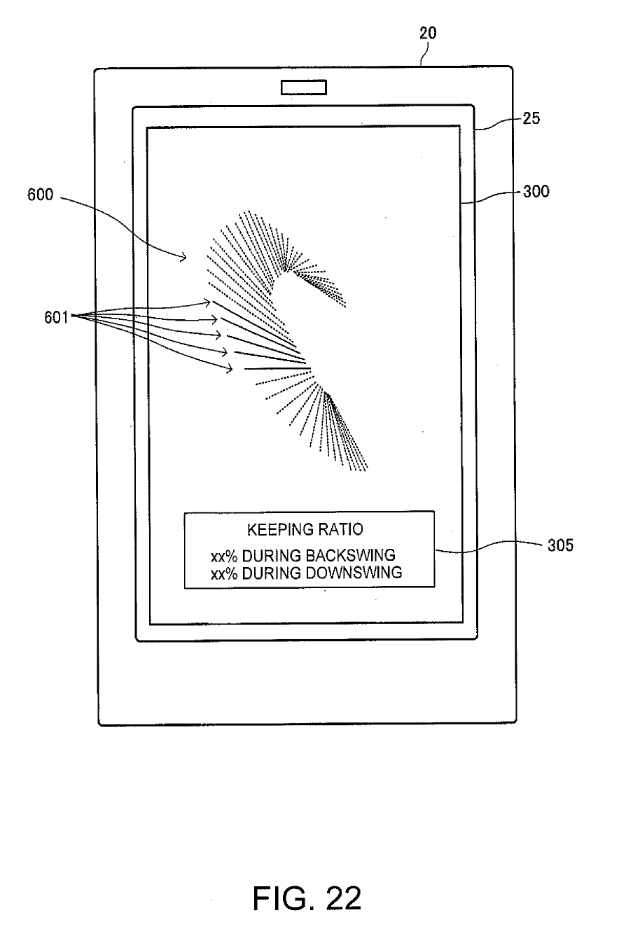

FIG. 21 illustrates an example in which the partially annular-belt shaped swing plane 500 is displayed as a trajectory of the predetermined portion of the golf club, but may display an image of the shaft at each time point in the same screen instead of the swing plane 500. FIG. 22 illustrates an example in which images 600 of the shaft at respective time points, and images 601 of the shaft at time points at which the shaft is included in a predetermined region are indicated by solid lines. Consequently, the user can differentiate the shaft (solid line) included in the predetermined region and the shaft (dotted line) not included therein from each other. A differentiation method is not limited to the method using the type of line, and may employ various methods such as a method using a color, a method using a line thickness, and a method using a blinking pattern.

### 4-4. Modification Examples of Function Sharing

A single swing analysis apparatus may be configured to have at least some of the functions of the swing analysis apparatus 20 of the first embodiment and at least some of the functions of the swing analysis apparatus 20 of the second embodiment.

A single swing analysis apparatus may be configured to have at least some of the functions of the swing analysis apparatus 20 of the first embodiment and at least some of the functions of the swing analysis apparatus 20 of the third embodiment.

A single swing analysis apparatus may be configured to have at least some of the functions of the swing analysis apparatus 20 of the second embodiment and at least some of the functions of the swing analysis apparatus 20 of the third embodiment.

A single swing analysis apparatus may be configured to have at least some of the functions of the swing analysis apparatus 20 of the first embodiment, at least some of the functions of the swing analysis apparatus 20 of the second embodiment, and at least some of the functions of the swing analysis apparatus 20 of the third embodiment.

### 5. Operations and Effects of Embodiments

(1) An electronic apparatus (swing analysis apparatus 20) according to any one of the above-described embodiments includes a presentation portion (the display section 25 or the sound output section 26) which presents a ratio between a length of a trajectory of a predetermined portion of an exercise equipment (golf club 3) and a length of a portion of the trajectory included in a predetermined region in a predetermined period of a swing, or presents a ratio between the predetermined period of the swing and time for which the predetermined portion of the exercise equipment (golf club 3) is included in the predetermined region in the predetermined period.

Therefore, the electronic apparatus (swing analysis apparatus 20) can quantitatively present, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

(2) In the electronic apparatus (swing analysis apparatus 20) according to any one of the above-described embodiments, the predetermined region is a region interposed between a first plane along a longitudinal direction of the exercise equipment and a second plane passing through the vicinity of the shoulder of a user, the first plane is a plane specified by a first axis along a target hit ball direction and a second axis along the longitudinal direction of the exercise equipment before starting the swing, and the second plane is a plane which includes the first axis and forms a predetermined angle with the first plane, or a plane which is parallel to the first plane.

(3) The electronic apparatus (swing analysis apparatus 20) according to any one of the above-described embodiments further includes a calculation portion (keeping ratio calculation portion 2110) which calculates a ratio between a length of a trajectory of a predetermined portion of an exercise equipment (golf club 3) and a length of a portion of the trajectory included in a predetermined region in a predetermined period of a swing, or calculates a ratio between the predetermined period of the swing and time for which the predetermined portion of the exercise equipment (golf club 3) is included in the predetermined region in the predetermined period.

Therefore, the electronic apparatus (swing analysis apparatus 20) can quantitatively calculate, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

(4) In the electronic apparatus (swing analysis apparatus 20) according to any one of the above-described embodiments, the predetermined region is a region interposed between a first plane (shaft plane SP) along a longitudinal direction of the exercise equipment (golf club 3) and a second plane (the shaft plane SP or the shoulder plane) passing through the vicinity of the shoulder of a user, the first plane is a plane specified by a first axis along a target hit ball direction and a second axis along the longitudinal direction of the exercise equipment before starting the swing, and the second plane is a plane (shaft plane SP) which includes the first axis and forms a predetermined angle with the first plane or a plane (shoulder plane) which is parallel to the first plane.

Therefore, if this ratio is used as at least one of indexes, for example, it is possible to objectively diagnose quality of a user's swing.

(5) In the electronic apparatus (swing analysis apparatus 20) of the above-described first embodiment or third embodiment, the calculation portion (keeping ratio calculation portion 2110) divides time-series data of positions of the predetermined portion in the predetermined period into a plurality of sections (S51), calculates a position of the predetermined portion in each section on the basis of time-series data for each section (S54), counts the number of positions included in the predetermined region among the positions in the respective sections (S58), and sets a value obtained by dividing the counted number by the number of sections as the ratio (S66).

The calculation portion (keeping ratio calculation portion 2110) uses time-series data of positions as data of positions in respective sections when counting the number of positions included in the predetermined region. In this case, the number of position data is reduced, and thus this is efficient since the number of times of determining whether or not each position is included in the predetermined region can be reduced. As a position in each section, for example, an average value of positions in each section or a representative position in a section may be used.

(6) In the electronic apparatus (swing analysis apparatus 20) of the above-described third embodiment, the calculation portion (keeping determination portion 219) determines whether or not a position of the predetermined portion is included in the predetermined region on the basis of an inclination (L) of the first plane in a predetermined plane (YZ plane) intersecting the first plane and the second plane, an inclination (U) of the second plane in the predetermined plane (YZ plane), and coordinates (Yₙ, Zₙ) of a position of the predetermined portion in the predetermined plane (YZ plane) (S56′).

In this case, the calculation portion (keeping determination portion 219) can perform the above determination through only multiplication and magnitude comparison, and thus a trigonometric function (a tan function or the like) is not required to be used. Therefore, the electronic apparatus (swing analysis apparatus 20) can reduce a calculation amount required in determination.

(7) In the electronic apparatus (swing analysis apparatus 20) according to any one of the above-described embodiments, the calculation portion (keeping ratio calculation portion 2110) calculates the ratio on the basis of output from an inertial sensor (sensor unit 10).

The inertial sensor can accurately measure a position of a predetermined portion of the exercise equipment. Therefore, the calculation portion (keeping ratio calculation portion 2110) can accurately calculate a ratio compared with a case of calculating a ratio on the basis of a swing image or the like.

(8) In the electronic apparatus (swing analysis apparatus 20) according to any one of the above-described embodiments, the predetermined period is at least one of a first period from starting of the swing to impact, a second period from starting of the swing to a top, a third period from the top to the impact, a fourth period from starting of the swing to halfway back, and a fifth period from halfway down to the impact.

Therefore, the electronic apparatus (swing analysis apparatus 20) can set a ratio presentation target or calculation target to a period from a predetermined timing of the swing to another predetermined timing.

(9) In the electronic apparatus (swing analysis apparatus 20) according to any one of the above-described embodiments, the predetermined period is each of the second period and the third period.

Therefore, the electronic apparatus (swing analysis apparatus 20) can set a ratio presentation target or calculation target to each of a backswing period and a downswing period.

(10) In the electronic apparatus (swing analysis apparatus 20) according to any one of the above-described embodiments, the predetermined period is each of the fourth period and the fifth period.

Therefore, the electronic apparatus (swing analysis apparatus 20) can set a ratio presentation target or calculation target to each of a first half backswing period and a second half downswing period.

(11) A system (swing analysis system 1) according to any one of the above-described embodiments includes the electronic apparatus (swing analysis apparatus 20) of the above-described embodiments and the inertial sensor (sensor unit 10).

Therefore, for example, if the inertial sensor (sensor unit 10) is mounted on, for example, an exercise equipment (golf club 3) or a user's body, the electronic apparatus (swing analysis apparatus 20) can quantitatively calculate, as a distance or temporal ratio, a relationship between a case where the predetermined portion is not included in the predetermined region in the predetermined period and a case where the predetermined portion is included in the predetermined region in the predetermined period, on the basis of output from the inertial sensor (sensor unit 10). This ratio can accurately indicate a feature of a swing trajectory in the predetermined period.

(12) A method (swing analysis process) according to any one of the above-described embodiments includes a procedure (S32) of presenting a ratio between a length of a trajectory of a predetermined portion of an exercise equipment (golf club 3) and a length of a portion of the trajectory included in a predetermined region in a predetermined period of a swing, or presenting a ratio between the predetermined period of the swing and time for which the predetermined portion of the exercise equipment (golf club 3) is included in the predetermined region in the predetermined period.

Therefore, according to the method (swing analysis process) of any one of the above-described embodiments, it is possible to quantitatively present, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

(13) A method (V zone keeping ratio calculation process) according to any one of the above-described embodiments includes a procedure (steps S28, S30, S28′ and S30′) of calculating a ratio between a length of a trajectory of a predetermined portion of an exercise equipment (golf club 3) and a length of a portion of the trajectory included in a predetermined region in a predetermined period of a swing, or calculating a ratio between the predetermined period of the swing and time for which the predetermined portion of the exercise equipment (golf club 3) is included in the predetermined region in the predetermined period.

Therefore, according to the method (V zone keeping ratio calculation process) of any one of the above-described embodiments, it is possible to quantitatively calculate, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

(14) A program (swing analysis program) according to any one of the above-described embodiments causes a computer (processing section 21) to execute a procedure (S32) of presenting a ratio between a length of a trajectory of a predetermined portion of an exercise equipment (golf club 3) and a length of a portion of the trajectory included in a predetermined region in a predetermined period of a swing, or presenting a ratio between the predetermined period of the swing and time for which the predetermined portion of the exercise equipment (golf club 3) is included in the predetermined region in the predetermined period.

Therefore, according to the program (swing analysis program) of any one of the above-described embodiments, the computer (processing section 21) can quantitatively present, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

(15) A program (V zone keeping ratio calculation program) according to any one of the above-described embodiments causes a computer (processing section 21) to execute a procedure (steps S28, S30, S28′ and S30′) of calculating a ratio between a length of a trajectory of a predetermined portion of an exercise equipment (golf club 3) and a length of a portion of the trajectory included in a predetermined region in a predetermined period of a swing, or calculating a ratio between the predetermined period of the swing and time for which the predetermined portion of the exercise equipment (golf club 3) is included in the predetermined region in the predetermined period.

Therefore, according to the program (V zone keeping ratio calculation program) of any one of the above-described embodiments, the computer (processing section 21) can quantitatively calculate, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

(16) A recording medium according to any one of the above-described embodiments records a program causing a computer (processing section 21) to execute a procedure of presenting a ratio between a length of a trajectory of a predetermined portion of an exercise equipment (golf club 3) and a length of a portion of the trajectory included in a predetermined region in a predetermined period of a swing, or presenting a ratio between the predetermined period of the swing and time for which the predetermined portion of the exercise equipment (golf club 3) is included in the predetermined region in the predetermined period.

Therefore, according to the recording medium of any one of the above-described embodiments, the computer (processing section 21) can quantitatively present, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

(17) A recording medium according to any one of the above-described embodiments records a program causing a computer (processing section 21) to execute a procedure of calculating a ratio between a length of a trajectory of a predetermined portion of an exercise equipment (golf club 3) and a length of a portion of the trajectory included in a predetermined region in a predetermined period of a swing, or calculating a ratio between the predetermined period of the swing and time for which the predetermined portion of the exercise equipment (golf club 3) is included in the predetermined region in the predetermined period.

Therefore, according to the recording medium of any one of the above-described embodiments, the computer (processing section 21) can quantitatively calculate, as a distance or temporal ratio, a relationship between a case where the predetermined portion is not included in the predetermined region in the predetermined period and a case where the predetermined portion is included in the predetermined region in the predetermined period. This ratio can accurately indicate a feature of a swing trajectory in the predetermined period.

### 6. Other Modification Examples

The invention is not limited to the present embodiment, and may be variously modified within the scope of the spirit of the invention.

For example, a plurality of sensor units 10 may be attached to the golf club 3 or parts such as the arms or the shoulders of the user 2, and the swing analysis apparatus 20 may perform a swing analysis process by using measured data from the plurality of sensor units 10.

In the above-described embodiments, the acceleration sensor 12 and the angular velocity sensor 14 are built into and are thus integrally formed as the sensor unit 10, but the acceleration sensor 12 and the angular velocity sensor 14 may not be integrally formed. Alternatively, the acceleration sensor 12 and the angular velocity sensor 14 may not be built into the sensor unit 10, and may be directly mounted on the golf club 3 or the user 2.

In the above-described embodiment, the sensor unit 10 and the swing analysis apparatus 20 are separately provided, but may be integrally formed so as to be attached to the golf club 3 or the user 2. The sensor unit 10 may have some of the constituent elements of the swing analysis apparatus 20 along with the inertial sensor (for example, the acceleration sensor 12 or the angular velocity sensor 14).

In other words, some or all of the functions of the swing analysis apparatus 20 may be installed on the sensor unit 10 side, and some of the functions of the sensor unit 10 may be installed on the swing analysis apparatus 20 side.

Some or all of the functions of the swing analysis apparatus 20 may be installed on a network server side (not illustrated). For example, the function of presenting swing analysis data (a function of notifying a user by using a sound, an image, or vibration) may be installed on the swing analysis apparatus 20 side, and the function of generating swing analysis data may be installed on the network server side.

In the above-described embodiments, an inertial sensor (sensor unit 10) of a type of being attached to the golf club 3 has been described, but the inertial sensor (an acceleration sensor and an angular velocity sensor) may be built into the golf club 3.

In the above-described embodiments, the swing analysis system analyzing a golf swing has been exemplified, but the invention is applicable to a swing analysis system diagnosing a swing in various sports such as tennis, badminton, or baseball.

The above-described embodiments and modification examples are only examples, and the invention is not limited thereto. For example, the embodiments and the respective modification examples may be combined with each other as appropriate.

For example, the invention includes substantially the same configuration (for example, a configuration in which functions, methods, and results are the same, or a configuration in which objects and effects are the same) as the configuration described in the embodiments. The invention includes a configuration in which an inessential part of the configuration described in the embodiments is replaced with another part. The invention includes a configuration which achieves the same operation and effect or a configuration capable of achieving the same object as in the configuration described in the embodiments. The invention includes a configuration in which a well-known technique is added to the configuration described in the embodiments.

The entire disclosure of Japanese Patent Application No. 2015-216748, filed Nov. 4, 2015 and No. 2016-031282, filed Feb. 22, 2016 are expressly incorporated by reference herein.

What is claimed is:

1. An electronic apparatus comprising:
a presentation portion that presents a ratio between a length of a trajectory of a predetermined portion of an exercise equipment and a length of a portion of the trajectory included in a predetermined region in a predetermined period of a swing, or presents a ratio between the predetermined period of the swing and time for which the predetermined portion of the exercise equipment is included in the predetermined region in the predetermined period.

2. An electronic apparatus comprising:
a calculation portion that calculates a ratio between a length of a trajectory of a predetermined portion of an exercise equipment and a length of a portion of the trajectory included in a predetermined region in a predetermined period of a swing, or calculates a ratio between the predetermined period of the swing and time for which the predetermined portion of the exercise equipment is included in the predetermined region in the predetermined period.

3. The electronic apparatus according to claim 1,
wherein the predetermined region is a region interposed between a first plane and a second plane, the first plane being specified by a first axis along a target hit ball direction and a second axis along the longitudinal direction of the exercise equipment before starting the swing, and the second plane being a plane which includes the first axis and forms a predetermined angle with the first plane, or a plane which is parallel to the first plane.

4. The electronic apparatus according to claim 2,
wherein the predetermined region is a region interposed between a first plane and a second plane, the first plane being specified by a first axis along a target hit ball direction and a second axis along the longitudinal direction of the exercise equipment before starting the swing, and the second plane being a plane which includes the first axis and forms a predetermined angle with the first plane, or a plane which is parallel to the first plane.

5. The electronic apparatus according to claim 2,
wherein the calculation portion
divides time-series data regarding positions of the predetermined portion in the predetermined period into a plurality of sections;
calculates a position of the predetermined portion in each section on the basis of time-series data for each section;
counts the number of positions included in the predetermined region among the positions in the respective sections; and
sets a value obtained by dividing the counted number by the number of sections as the ratio.

6. The electronic apparatus according to claim 3,
wherein the calculation portion determines whether or not a position of the predetermined portion is included in the predetermined region on the basis of an inclination of the first plane in a predetermined plane intersecting the first plane and the second plane, an inclination of the second plane in the predetermined plane, and coordinates of a position of the predetermined portion in the predetermined plane.

7. The electronic apparatus according to claim 4,
wherein the calculation portion determines whether or not a position of the predetermined portion is included in the predetermined region on the basis of an inclination of the first plane in a predetermined plane intersecting the first plane and the second plane, an inclination of the second plane in the predetermined plane, and coordinates of a position of the predetermined portion in the predetermined plane.

8. The electronic apparatus according to claim 5,
wherein the calculation portion calculates the ratio on the basis of output from an inertial sensor.

9. The electronic apparatus according to claim 6,
wherein the calculation portion calculates the ratio on the basis of output from an inertial sensor.

10. The electronic apparatus according to claim 1,
wherein the predetermined period is at least one of a first period from starting of the swing to impact, a second period from starting of the swing to a top, a third period from the top to the impact, a fourth period from starting of the swing to halfway back, and a fifth period from halfway down to the impact.

11. The electronic apparatus according to claim 2,
wherein the predetermined period is at least one of a first period from starting of the swing to impact, a second period from starting of the swing to a top, a third period from the top to the impact, a fourth period from starting of the swing to halfway back, and a fifth period from halfway down to the impact.

12. The electronic apparatus according to claim 10,
wherein the predetermined period is a period including the second period and the third period.

13. The electronic apparatus according to claim 11,
wherein the predetermined period is a period including the second period and the third period.

14. The electronic apparatus according to claim 10,
wherein the predetermined period is a period including the fourth period and the fifth period.

15. The electronic apparatus according to claim 11,
wherein the predetermined period is a period including the fourth period and the fifth period.

16. A system comprising:
the electronic apparatus according to claim 8; and
the inertial sensor.

17. A presentation method comprising:
presenting a ratio between a length of a trajectory of a predetermined portion of an exercise equipment and a length of a portion of the trajectory included in a predetermined region in a predetermined period of a swing, or presenting a ratio between the predetermined period of the swing and time for which the predetermined portion of the exercise equipment is included in the predetermined region in the predetermined period.

18. The presentation method according to claim 17, further comprising:
presenting a trajectory in the predetermined period of the swing.

19. The presentation method according to claim 17,
wherein the predetermined period is at least one of a first period from starting of the swing to impact, a second period from starting of the swing to a top, a third period from the top to the impact, a fourth period from starting of the swing to halfway back, and a fifth period from halfway down to the impact.

20. The presentation method according to claim 17,
wherein the predetermined region is a region interposed between a first plane and a second plane, the first plane being specified by a first axis along a target hit ball direction and a second axis along the longitudinal direction of the exercise equipment before starting the swing, and the second plane being a plane which includes the first axis and forms a predetermined angle with the first plane, or a plane which is parallel to the first plane.

21. The presentation method according to claim 20, further comprising:
displaying the first plane and the second plane.

22. A recording medium recording a program causing a computer to execute:
calculating a ratio between a length of a trajectory of a predetermined portion of an exercise equipment and a length of a portion of the trajectory included in a predetermined region in a predetermined period of a swing, or calculating a ratio between the predetermined period of the swing and time for which the predetermined portion of the exercise equipment is included in the predetermined region in the predetermined period.
